(19) United States
(12) Patent Application Publication
(10) Pub. No.: US 2008/0048147 A1
(43) Pub. Date: Feb. 28, 2008

(54) GLYCERIN SYSTEMS

(75) Inventor: Edward Eaton, Phoenix, AZ (US)

Correspondence Address: STONEMAN LAW OFFICES, LTD, 3113 NORTH 3RD STREET, PHOENIX, AZ, 85012, US

(73) Assignee: SANIMAX INDUSTRIES INC., Montreal (CA)

(21) Appl. No.: 11/842,871

(22) Filed: Aug. 21, 2007

Related U.S. Application Data
(60) Provisional application No. 60/823,185, filed on Aug. 22, 2006.
(60) Provisional application No. 60/866,773, filed on Nov. 21, 2006.

(51) Int. Cl. C09K 5/20

(52) U.S. Cl. 252/74; 252/77

(57) ABSTRACT

A method for manufacturing antifreeze comprising manufacturing biodiesel; collecting the byproduct glycerin of such biodiesel manufacture; adding water to such glycerin to generate at least one mixture of glycerin and water; adding at least one anticorrosive additive to such at least one mixture of glycerin and water to generate at least one antifreeze; and placing such at least one antifreeze into at least one automotive cooling system. The antifreeze viscosity is adapted to be within the viscosity range between propylene-glycol-based antifreeze and ethylene-glycol-based antifreeze. Also disclosed are “blended” biodiesel-derived glycerin/ethylene glycol coolant/antifreeze products and biodiesel-derived glycerin/propylene glycol coolant/antifreeze products. Marketing methods are also disclosed, along with material compositions.

### CROSS-REFERENCE TO RELATED APPLICATION

The present application is related to and claims priority from prior provisional application Ser. No. 60/823,185, filed Aug. 22, 2006, entitled “Glycerin Systems”, and is related to and claims priority from prior provisional application Ser. No. 60/866,773, filed Nov. 21, 2006, entitled “Glycerin Systems”, the contents of which are incorporated herein by this reference and are not admitted to be prior art with respect to the present invention by the mention in this cross-reference section.

### BACKGROUND

The present invention relates to glycerin systems. More particularly, the present invention relates to methods for using glycerin as an antifreeze ingredient. Even more particularly, the present invention relates to methods for manufacturing glycerin antifreeze from renewable oils as a byproduct of biodiesel production. Further, the present invention relates to glycerin-based antifreeze adapted to have a viscosity between the viscosity of propylene-glycol-based antifreeze and the viscosity of ethylene-glycol-based antifreeze. Further, the present invention relates to glycerin-based antifreeze having the ability to withstand the rigors of high temperature engine environments. Even further, the present invention relates to “blended” glycerin-based antifreeze with ethylene glycol based coolant/antifreeze or propylene glycol based coolant/antifreeze. Even further, the present invention relates to a system of marketing glycerin-based antifreeze as an environmentally friendly (or “green”) product that requires little or no consumer behavior modification to implement the use of such glycerin-based antifreeze. Even further, the present invention relates to reducing costs of antifreeze in systems where low toxicity is needed.

The term biodiesel generally refers to a diesel-equivalent processed fuel derived from biological sources (e.g., vegetable oils) which can be used in unmodified diesel-engine vehicles. Biodiesel is biodegradable and non-toxic, and typically produces about 60% less net CO₂ emissions than petroleum-based diesel. Glycerin is a chemical compound with the formula C₃H₅(OH)₃. Glycerin is also referred to as glycerine, propane-1,2,3-triol, 1,2,3-propanetriol, 1,2,3-trihydroxypropane, glyceritol, glycyl alcohol, and other names. Being a sugar alcohol, glycerin has a sweet taste and is non-toxic.

No system exists that generates glycerin antifreeze as a byproduct of biodiesel production. Further, no system exists that provides glycerin-based antifreeze adapted to have a viscosity between the viscosity of propylene-glycol-based antifreeze and the viscosity of ethylene-glycol-based antifreeze. No system exists that provides “blended” glycerin-based coolant/antifreeze products blended with ethylene glycol based coolant/antifreeze or propylene glycol based coolant/antifreeze.

Therefore, a need exists for a system that generates glycerin antifreeze as a byproduct of biodiesel production. Further, a need exists for a system that provides glycerin-based antifreeze adapted to have a viscosity between the viscosity of propylene-glycol-based antifreeze and the viscosity of ethylene-glycol-based antifreeze.

### OBJECTS AND FEATURES OF THE INVENTION

A primary object and feature of the present invention is to provide a glycerin system filling the above needs.

It is a further object and feature of the present invention to provide such a system that provides glycerin antifreeze as a byproduct of biodiesel production. It is a further object and feature of the present invention to provide glycerin-based antifreeze adapted to have a viscosity between the viscosity of propylene-glycol-based antifreeze and the viscosity of ethylene-glycol-based antifreeze.

It is a further object and feature of this invention to provide non-toxic mixtures using glycerin permitting cost efficiencies and also additions of glycerin to existing antifreezes in a variety of disclosed amounts.

It is a further object and feature of the present invention to provide methods of replacing existing coolant, comprising ethylene glycol or propylene glycol, in heat exchange systems with biodiesel derived glycerin-based coolant/antifreeze.

It is a further object and feature of the present invention to provide “blended” biodiesel derived glycerin/ethylene glycol or biodiesel derived glycerin/propylene glycol coolant/antifreeze blends for use in heat exchange systems.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a method, comprising the steps of: manufacturing biodiesel; collecting the byproduct glycerin of such biodiesel manufacturing; adding at least one anticorrosive additive to such glycerin to generate at least one antifreeze; and placing such at least one antifreeze into at least one automotive cooling system. Moreover, it provides such a method, further comprising the step of adding water to such at least one antifreeze.

In accordance with another preferred embodiment hereof, this invention provides a method, comprising the steps of: collecting convertible oils from animal and/or vegetable sources; converting such convertible oils into biodiesel and glycerin; and adding at least one anticorrosive additive to such glycerin to produce at least one antifreeze. Additionally, it provides such a method, further comprising the step of adding water to such at least one antifreeze. Also, it provides such a method, further comprising the step of using such at least one antifreeze in at least one automobile. In addition, it provides such a method, further comprising the step of using such at least one antifreeze in at least one diesel truck. And, it provides such a method, further comprising the step of using such at least one antifreeze in at least one industrial heat exchanger. Further, it provides such a method, further comprising the step of marketing such at least one antifreeze as “biodiesel-derived” antifreeze. Even further, it provides such a method, further comprising the step of marketing such at least one antifreeze as “green glycerin”. Moreover, it provides such a method, further comprising the step of marketing such at least one antifreeze as “green glycerine”. Additionally, it provides such a method, further comprising the step of marketing such at least one antifreeze as “green” antifreeze. Also, it provides such a method, further comprising the step of marketing such at least one antifreeze as “eco-friendly” antifreeze. In addition, it provides such a method, further comprising the step of packaging such at least one antifreeze in at least one green bottle. And, it provides such a method, further comprising the step of packaging such at least one antifreeze with at least one green label. Further, it provides such a method, further comprising the step of providing wholesale sales and distribution of such at least one antifreeze. Even further, it provides such a method, further comprising the step of selling such at least one antifreeze in USDA hardiness zones 7a-11. Moreover, it provides such a method, further comprising the step of selling such at least one antifreeze in USDA hardiness zones 5a-11. Additionally, it provides such a method, further comprising the step of certifying such at least one antifreeze as meeting ASTM D 3306—Standard Specification for Glycol Base Engine Coolant for Automobile and Light-Duty Service. Also, it provides such a method, further comprising the step of certifying such at least one antifreeze as meeting ASTM D 2610—Standard Specification for Fully-Formulated Glycol Base Engine Coolant for Heavy-Duty Engines. In addition, it provides such a method, further comprising the step of adjusting the viscosity of such at least one antifreeze to between the viscosity of at least one propylene-glycol-based antifreeze and the viscosity of at least one ethylene-glycol-based antifreeze. And, it provides such a method, further comprising the step of approximately matching the viscosity of such at least one antifreeze to the viscosity of at least one propylene-glycol-based antifreeze. Further, it provides such a method, further comprising the step of approximately matching the viscosity of such at least one antifreeze to the viscosity of at least one ethylene-glycol-based antifreeze. Even further, it provides such a method, further comprising the step of replacing an ethylene glycol based coolant in a heat exchange system, over at least one interval of time, with such glycerin comprising antifreeze. Moreover, it provides such a method, further comprising the step of replacing a propylene glycol based coolant in a heat exchange system, over at least one interval of time, with such glycerin comprising antifreeze. Additionally, it provides such a method, further comprising the step of replacing a brine based coolant in a heat exchange system, over at least one interval of time, with such glycerin comprising antifreeze. Also, it provides such a product manufactured by the process of collecting convertible oils from animal and/or vegetable sources; converting such convertible oils into biodiesel and glycerin; and adding at least one anticorrosive additive to such glycerin to produce at least one antifreeze. In addition, it provides such a product manufactured by the process of collecting convertible oils from animal and/or vegetable sources; converting such convertible oils into biodiesel and glycerin; and adding at least one anticorrosive additive to such glycerin to produce at least one antifreeze; and approximately matching the viscosity of such at least one antifreeze to the viscosity of at least one propylene-glycol-based antifreeze. And, it provides such a product manufactured by the process of collecting convertible oils from animal and/or vegetable sources; converting such convertible oils into biodiesel and glycerin; and adding at least one anticorrosive additive to such glycerin to produce at least one antifreeze; and approximately matching the viscosity of such at least one antifreeze to the viscosity of at least one ethylene-glycol-based antifreeze.

In accordance with another preferred embodiment hereof, this invention provides an antifreeze, adapted to have a viscosity between the viscosity of 50% ethylene glycol antifreeze and the viscosity of 50% propylene glycol antifreeze, comprising glycerin. Further, it provides such an antifreeze, adapted to have the viscosity of 50% ethylene glycol based antifreeze. Even further, it provides such a antifreeze, adapted to have the viscosity of 50% propylene glycol based antifreeze. Moreover, it provides such a antifreeze, wherein such glycerin comprises biodiesel-derived glycerin.

In accordance with another preferred embodiment hereof, this invention provides a glycerin based antifreeze comprising: about 55 percent volume of biodiesel derived glycerin; about 40 percent volume deionized water; and about 3.5% v/v Nitrite, molybdate Organic Acid Technology Fully Formulated Extended Service Interval Coolant.

In accordance with another preferred embodiment hereof, this invention provides a glycerin based antifreeze comprising: about 55 percent volume biodiesel derived glycerin; about 43 percent volume deionized water; and about 1 percent fully formulated conventional antifreeze additive.

In accordance with another preferred embodiment hereof, this invention provides a blended coolant/antifreeze comprising: at least 25 percent volume bio-diesel derived glycerin; and at least one amount of ethylene glycol. Additionally, it provides such a blended coolant/antifreeze, comprising at least 50 percent biodiesel derived glycerin. Also, it provides such a blended coolant/antifreeze, comprising at least 75 percent biodiesel derived glycerin.

In accordance with another preferred embodiment hereof, this invention provides a blended coolant/antifreeze comprising: at least 25 percent biodiesel derived glycerin; and at least one amount of propylene glycol. In addition, it provides such a blended coolant/antifreeze, comprising at least 50 percent biodiesel derived glycerin. And, it provides such a blended coolant/antifreeze, comprising at least 75 percent biodiesel derived glycerin.

In accordance with another preferred embodiment hereof, this invention provides a blended coolant/antifreeze comprising: at least one amount of biodiesel derived glycerin; at least one amount of ethylene glycol; and at least one amount of at least one anti-corrosive additive. Further, it provides such a blended coolant/antifreeze, wherein such at least one amount of at least amount of biodiesel derived glycerin comprises about 25 percent biodiesel derived glycerin; and wherein such at least one amount of ethylene glycol comprises about 75 percent ethylene glycol. Even further, it provides such a blended coolant/antifreeze, wherein such at least one amount of at least amount of biodiesel derived glycerin comprises about 50 percent biodiesel derived glycerin; and wherein such at least one amount of ethylene glycol comprises about 50 percent ethylene glycol. Even further, it provides such a blended coolant/antifreeze, wherein such at least one amount of at least amount of biodiesel derived glycerin comprises about 75 percent biodiesel derived glycerin; and wherein such at least one amount of ethylene glycol comprises about 25 percent ethylene glycol.

In accordance with another preferred embodiment hereof, this invention provides a blended coolant/antifreeze comprising: at least one amount of biodiesel derived glycerin; at least one amount of propylene glycol; and at least one amount of at least one anti-corrosive additive. Even further, it provides such a blended coolant/antifreeze, wherein such at least one amount of at least amount of biodiesel derived glycerin comprises about 25 percent biodiesel derived glycerin; and wherein such at least one amount of propylene glycol comprises about 75 percent propylene glycol. Even further, it provides such a blended coolant/antifreeze, wherein such at least one amount of at least amount of biodiesel derived glycerin comprises about 50 percent biodiesel derived glycerin; and wherein such at least one amount of propylene glycol comprises about 50 percent propylene glycol. Even further, it provides such a blended coolant/antifreeze, wherein such at least one amount of at least amount of biodiesel derived glycerin comprises about 75 percent biodiesel derived glycerin; and wherein such at least one amount of propylene glycol comprises about 25 percent propylene glycol.

In accordance with another preferred embodiment hereof, this invention provides each and every novel feature, element, combination, step and/or method disclosed or suggested herein.

### BRIEF DESCRIPTION OF THE DRAWINGS

FIG. 1 shows a diagram illustrating a method according to a preferred embodiment of the present invention.

FIG. 2 shows a diagram illustrating another method according to the preferred embodiment of the present invention.

FIG. 3 shows a diagram illustrating the viscosities of glycerin, ethylene glycol, and propylene glycol in water mixtures.

FIG. 4 shows a plot of the freezing points for various aqueous solutions of glycerin.

FIG. 5 shows a plot of the boiling points for various aqueous solutions of glycerin.

FIG. 6 shows a diagram illustrating a method of producing “blended” versions of a coolant/antifreeze according to a preferred embodiment of the present invention.

### DETAILED DESCRIPTION OF THE BEST MODES AND PREFERRED EMBODIMENTS OF THE INVENTION

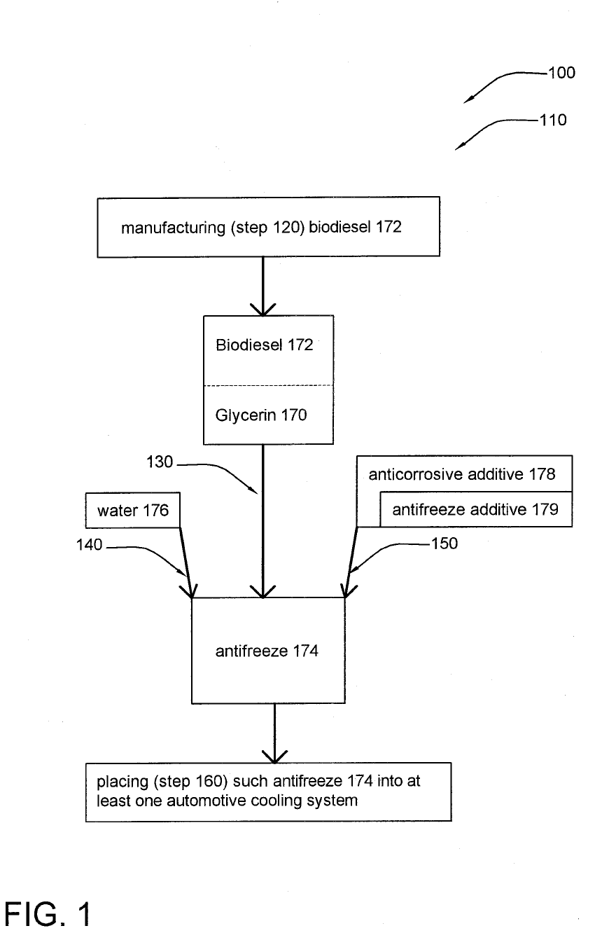

FIG. 1 shows a diagram illustrating method 110 according to a preferred embodiment of the present invention. Preferably, glycerin system 100 comprises manufacturing glycerin 170 as a byproduct of biodiesel 172 production and using such glycerin 170 as an antifreeze 174, as shown. Preferably, glycerin system 100 comprises method 110, as shown.

Preferably, method 110 comprises the steps of: manufacturing (step 120) biodiesel 172; collecting (step 130) the byproduct glycerin 170 of such biodiesel 172 manufacture; adding at least one anticorrosive additive 178 (step 150) to such glycerin 170 to generate at least one antifreeze 174; and placing (step 160) such antifreeze 174 into at least one automotive cooling system, as shown (at least embodying herein the step of manufacturing biodiesel; and at least embodying herein the step of collecting the byproduct glycerin of such biodiesel manufacturing; and at least embodying herein the step of adding at least one anticorrosive additive to such glycerin to generate at least one antifreeze; and at least embodying herein the step of placing such at least one antifreeze into at least one automotive cooling system). Preferably, method 110 further comprises the step of adding water 176 (step 140) to such antifreeze 174, as shown (at least embodying herein the step of adding water to such at least one antifreeze). Upon reading the teachings of this specification, those with ordinary skill in the art will now understand that, under appropriate circumstances, considering such issues as advances in technology, user preference, etc., other method steps, such as packaging the antifreeze, adding other additives, etc., may suffice.

Preferably, glycerin system 100 comprises antifreeze 174 manufactured according to method 110, as shown.

Manufacturing 120 biodiesel preferably comprises transesterification of triglycerides with alcohol to form esters and glycerin 170, usually using a strong base as a catalyst. Preferably, manufacturing 120 biodiesel comprises transesterification of animal and/or vegetable oils with ethanol and/or methanol to form ethyl esters of fatty acids (the biodiesel 172) and glycerin 170, preferably using potassium hydroxide as a catalyst. Upon reading the teachings of this specification, those with ordinary skill in the art will now understand that, under appropriate circumstances, considering such issues as advances in technology, user preference, etc., other biodiesel manufacturing methods, such as using acid as a catalyst, using other alcohols, etc., may suffice.

Collecting 130 the byproduct glycerin 170 of such biodiesel 172 manufacture comprises separating the glycerin 170 from the biodiesel 172. Biodiesel 172 is less dense than glycerin 170 and is not miscible with glycerin 170, so glycerin 170 can be conveniently collected from the bottom of the biodiesel reaction vessel after the transesterification reaction is complete. Collecting 130 the byproduct glycerin 170 of such biodiesel manufacture also comprises refining glycerin 170 to remove impurities, as needed.

Preferably, adding water 176 (step 140) to such glycerin 170 to generate a mixture of glycerin 170 and water 176 comprises adding water 176 to the glycerin 170 to form a mixture between about 30% glycerin 170/70% water 176 and about 70% glycerin 170/30% water 176, by volume, depending on the desired properties (viscosity, freezing point, boiling point, etc.) of the antifreeze 174 being manufactured. More preferably, a mixture between about 40% glycerin 170/60% water 176 and about 60% glycerin 170/40% water 176 is used.

Glycerin 170 is also chemically identified as CAS number [56-81-5], glycerol, glycerine, propane-1,2,3-triol, 1,2,3-propanetriol, etc. Water 176 preferably comprises purified water so that dissolved minerals are not introduced into the cooling system.

Preferably, adding 150 at least one anticorrosive additive 178 to such mixture of glycerin 170 and water 176 to generate at least one antifreeze 174 comprises adding at least one fully formulated conventional antifreeze additive 179 (known in the coolant industry as an antifreeze “add pack”, available from manufacturers such as, for example, Additives, Inc., of Denver, Col., U.S.) to such mixture of glycerin 170 and water 176, as shown.

Preferably, the mixture of glycerin 170 and antifreeze additive 179 comprises antifreeze 174. More preferably, the mixture of glycerin 170, water 176, and antifreeze additive 179 comprises antifreeze 174, as shown. Antifreeze 174 is preferably available to consumers as either concentrate (glycerin 170 and antifreeze additive 179) or premixed (glycerin 170, water 176, and antifreeze additive 179). In the case of concentrate, the correct amount of water 176 must be added to the concentrate by the consumer.

Preferably, antifreeze 174 meets the standard of ASTM D3306—“Standard Specification for Glycol Base Engine Coolant for Automobile and Light-Duty Service”. In an alternative preferred embodiment, the antifreeze 174 meets the standard of ASTM D 2610—“Standard Specification for Fully-Formulated Glycol Base Engine Coolant for Heavy-Duty Engines”. Upon reading the teachings of this specification, those with ordinary skill in the art will now understand that, under appropriate circumstances, considering such issues as advances in technology, user preference, etc., other antifreeze standards, such as other national standards, international standards, foreign standards, legal standards, custom standards specified by the consumer, etc., may suffice.

Preferably, placing 160 such antifreeze 174 into at least one automotive cooling system comprises replacing ethylene glycol antifreeze and/or propylene glycol antifreeze previously in an automobile with the glycerin-based antifreeze 174. Preferably, placing 160 such antifreeze 174 into at least one automotive cooling system comprises placing the glycerin-based antifreeze 174 into a new vehicle.

Preferably, antifreeze 174 is placed into an existing cooling system comprising an ethylene glycol coolant. Preferably, a wide range of antifreeze 174 concentrations may be added to an existing cooling system comprising ethylene glycol as a coolant with no apparent adverse effects (See Table 15, 16, 18, 19, 22, and 23). Preferably, a user may add antifreeze 174 to an existing cooling system comprising an ethylene glycol coolant in concentrations ranging from at least measurable amounts of antifreeze 174 to create a “blended” antifreeze (comprising antifreeze 174 and ethylene glycol coolant) and up to and eventually, over time, comprising 100% antifreeze 174, to essentially replace such ethylene glycol coolant in such existing cooling system with antifreeze 174. Such a conversion has the effect of “converting” the cooling system to a less toxic system, since antifreeze 174 is essentially nontoxic, such that the cooling system may be considered more “green”, “environmentally friendly”, etc.

Preferably, antifreeze 174 is placed into an existing cooling system comprising a propylene glycol based coolant/antifreeze. Preferably, a wide range of antifreeze 174 concentrations may be added to such an existing cooling system comprising propylene glycol as a coolant/antifreeze with no adverse effects (See Table 16, 17, 20, 21, 24, and 25). Preferably, a user may add antifreeze 174 to an existing cooling system comprising a propylene glycol coolant in concentrations ranging from at least measurable amounts of antifreeze 174 to create a “blended” antifreeze (comprising antifreeze 174 and ethylene glycol coolant) and up to and eventually, over time, comprising 100% antifreeze 174, to essentially replace such propylene glycol coolant in such existing cooling system with antifreeze 174. Such a conversion has the effect of “converting” the cooling system to a less toxic system, since antifreeze 174 is essentially nontoxic, such that the cooling system may be considered more “green”, “environmentally friendly”, etc.

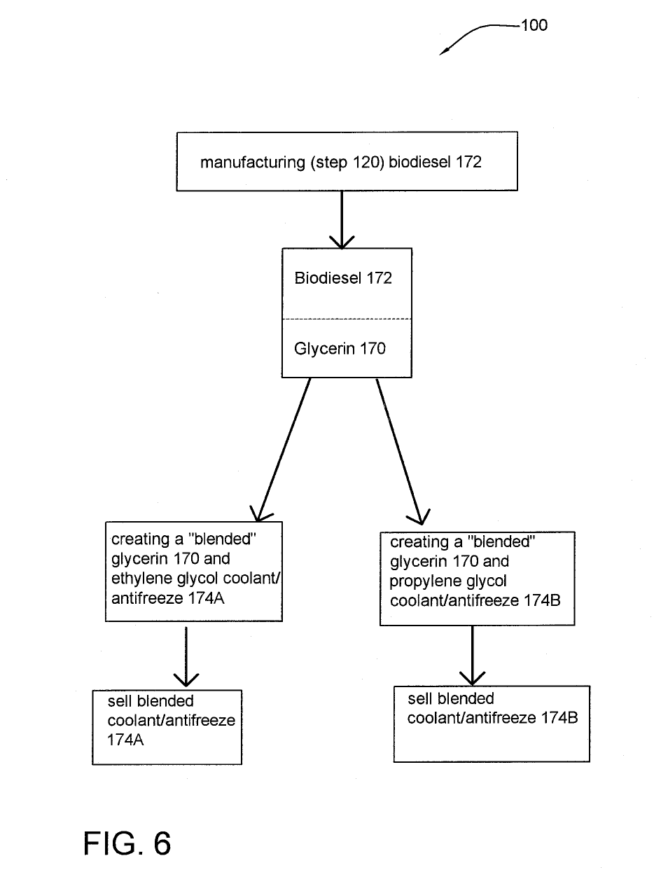

FIG. 6 shows a diagram illustrating a method of producing “blended” versions of a coolant/antifreeze according to a preferred embodiment of the present invention.

After the production and collection of glycerin 170, as described above, preferably, “blended” versions of antifreeze 174A comprising glycerin 170 and ethylene glycol coolant/antifreeze may preferably be manufactured and sold, as shown in FIG. 6. Preferably, an about 25% glycerin 170/about 75% ethylene glycol coolant/antifreeze may be manufactured and sold. More preferably, an about 50% glycerin 170/about 50% ethylene glycol coolant/antifreeze may be manufactured and sold. Most preferably, an about 75% glycerin 170/about 25% ethylene glycol antifreeze/coolant may be manufactured and sold. Preferably, such “blends” preferably comprise an anticorrosive additive (also known as a corrosion inhibitor). Such “blended” versions give consumers choice and permit consumers to adapt behavior to different blends of coolant/antifreeze over time.

For systems requiring low toxicity (as compared with ethylene glycol cooling systems), “blended” versions of antifreeze 174B comprising propylene glycol may be manufactured and sold. Preferably, an about 25% glycerin 170/about 75% propylene glycol coolant/antifreeze may be manufactured and sold. More preferably, an about 50% glycerin 170/about 50% propylene glycol coolant/antifreeze may be manufactured and sold. Most preferably, an about 75% glycerin 170/about 25% propylene glycol coolant/antifreeze may be manufactured and sold. Preferably, such “blends” preferably comprise an anticorrosive additive (also known as a corrosion inhibitor). Again, the “blended” versions give consumers choice in the marketplace and permit consumers to gradually adapt their behavior over time to environmentally friendly coolant/antifreeze solutions. The above “blended” antifreeze coolants are a cost advantage to users since the production of glycerin is a low-cost process. Further, blending glycerin (essentially no toxicity) with a propylene glycol based coolant/antifreeze (essentially no toxicity) creates an essentially nontoxic blended coolant/antifreeze.

Also preferably, preferred “blended” versions of antifreeze may be added to existing cooling systems over time so that a cooling system may switch from an ethylene glycol coolant/antifreeze to a “green”, environmentally friendly“, etc., antifreeze/coolant. Preferably, “blended” versions of antifreeze are placed into existing heat exchange systems comprising an ethylene glycol coolant/antifreeze or a propylene glycol coolant/antifreeze.

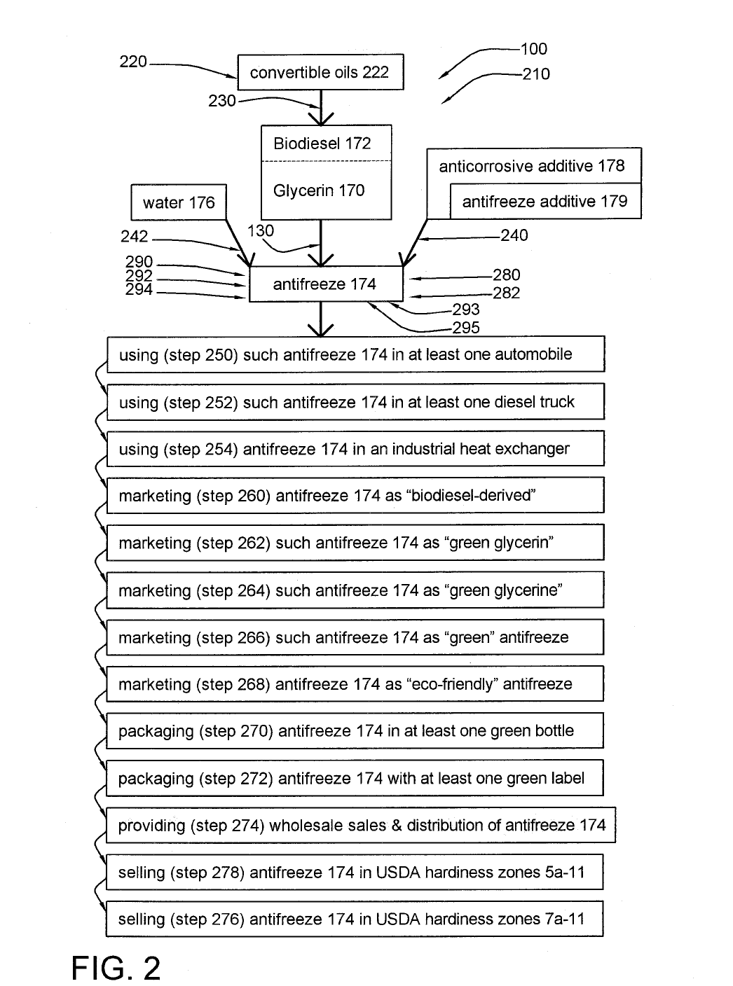

FIG. 2 shows a diagram illustrating method 210 according to the preferred embodiment of the present invention. Preferably, glycerin system 100 comprises method 210, as shown.

Preferably, method 210 comprises the steps of: collecting (step 220) convertible oils 222 from animal and/or vegetable sources; converting (step 230) such convertible oils 222 into biodiesel 172 and glycerin 170; and adding (step 240) at least one anti-corrosive additive 178 to such glycerin 170 to produce at least one antifreeze 174, as shown (at least embodying herein the step of collecting convertible oils from animal and/or vegetable sources; and at least embodying herein the step of converting such convertible oils into biodiesel and glycerin; and at least embodying herein the step of adding at least one anti-corrosive additive to such glycerin to produce at least one antifreeze). Preferably, method 210 further comprises the step of adding water 176 (step 242) to such antifreeze 174, as shown.

Preferably, convertible oils 222 comprise oils (generally triglycerides that are liquid at room temperature) and/or greases (generally triglycerides that are soft solids at room temperature) from animal and/or vegetable sources. Examples include used frying oil, yellow grease, pig skin grease, new vegetable or seed oil, etc.

Preferably, method 210 further comprises the step of using (step 250) such antifreeze 174 in at least one automobile, as shown (at least embodying herein the step of using such at least one antifreeze in at least one automobile). Preferably, for the purposes of this specification an automobile comprises any vehicle utilizing a gasoline engine. Preferably, method 210 further comprises the step of using (step 252) such antifreeze 174 in at least one diesel truck, as shown (at least embodying herein the step of using such at least one antifreeze in at least one diesel truck). Preferably, for the purposes of this specification a diesel truck comprises any vehicle utilizing a diesel engine. Preferably, method 210 further comprises the step of using (step 254) such antifreeze 174 in at least one industrial heat exchanger, as shown (at least embodying herein the step of using such at least one antifreeze in at least one industrial heat exchanger). Preferably, antifreeze 174 preferably replaces, partially or, preferably, entirely, ethylene glycol and/or propylene glycol antifreeze in automobiles, diesel trucks, and industrial heat exchangers to provide glycerin-based antifreeze 174 which is less toxic and environmentally renewable.

Preferably, method 210 further comprises the step of marketing (step 260) such antifreeze 174 as “biodiesel-derived” antifreeze, as shown (at least embodying herein the step of marketing such at least one antifreeze as “biodiesel-derived” antifreeze). The term “biodiesel-derived” will communicate to consumers that antifreeze 174 is derived from biodiesel manufacturing which is an environmentally friendly process. Preferably, method 210 further comprises the step of marketing (step 262) such antifreeze 174 as “green glycerin”, as shown (at least embodying herein the step of marketing such at least one antifreeze as “green glycerin”). The term “green glycerin” will communicate to consumers that antifreeze 174 comprises glycerin 170 from an environmentally friendly source. Preferably, method 210 further comprises the step of marketing (step 264) such antifreeze 174 as “green glycerine”, as shown, which is a common alternative spelling of “glycerin” (at least embodying herein the step of marketing such at least one antifreeze as “green glycerine”). Preferably, method 210 further comprises the step of marketing (step 266) such antifreeze 174 as “green” antifreeze, as shown (at least embodying herein the step of marketing such at least one antifreeze as “green” antifreeze). The term “green” is known to consumers to designate an environmentally friendly product. Preferably, method 210 further comprises the step of marketing (step 268) such antifreeze 174 as “eco-friendly” antifreeze, as shown (at least embodying herein the step of marketing such at least one antifreeze as “eco-friendly” antifreeze). The term “eco-friendly” is known to consumers to designate an environmentally friendly product. Preferably, after learning about the environmental benefits of antifreeze 174, consumers will be favorably inclined to buy and use antifreeze 174. It is noted that some consumers may be even more favorably inclined to buy antifreeze using biodiesel glycerin when the biodiesel process uses only oils derived from vegetable material (i.e., not derived from animal products); and it is thus also preferred to derive the glycerin described herein from such selected oils and further, preferably, to market such antifreeze for such consumers (for example, “Vegans”).

Preferably, method 210 further comprises the step of packaging (step 270) such at least one antifreeze 174 in at least one green bottle, as shown (at least embodying herein the step of packaging such at least one antifreeze in at least one green bottle). Preferably, method 210 further comprises the step of packaging (step 272) such at least one antifreeze 174 with at least one green label, as shown (at least embodying herein the step of packaging such at least one antifreeze with at least one green label). The color green is known to consumers to frequently designate an environmentally friendly product. Preferably, after learning about the environmental benefits of antifreeze 174, consumers will be favorably inclined to buy and use antifreeze 174.

Preferably, method 210 further comprises the step of providing (step 274) wholesale sales and distribution of such at least one antifreeze 174, as shown (at least embodying herein the step of providing wholesale sales and distribution of such at least one antifreeze). A 40% glycerin 170/60% water 176 mixture freezes at about −20 degrees Celsius. A 50% glycerin 170/50% water 176 mixture freezes at about −30 degrees Celsius. A 60% glycerin 170/60% water 176 mixture freezes at about −40 degrees Celsius. Therefore, antifreeze 174 is not suited for extremely cold climates (such as arctic or subarctic conditions) without further modifying the freeze point of antifreeze 174.

Preferably, method 210 further comprises the step of selling (step 278) such antifreeze 174 in USDA hardiness zones 5a-11, as shown, where the minimum yearly temperature is about −30 degrees Celsius (at least embodying herein the step of selling such at least one antifreeze in USDA hardiness zones 5a-11). More preferably, method 210 further comprises the step of selling (step 276) such antifreeze 174 in USDA hardiness zones 7a-11, as shown, where the minimum yearly temperature is about −20 degrees Celsius (at least embodying herein the step of selling such at least one antifreeze in USDA hardiness zones 7a-11). Upon reading the teachings of this specification, those with ordinary skill in the art will now understand that, under appropriate circumstances, considering such issues as advances in technology, user preference, etc., other climate-centered marketing, such as selling the antifreeze in locations between the Tropic of Cancer and the Tropic of Capricorn, selling the antifreeze for summer use in four-season climates, etc., may suffice.

Preferably, method 210 further comprises the step of certifying (step 280) antifreeze 174 as meeting ASTM D 3306—“Standard Specification for Glycol Base Engine Coolant for Automobile and Light-Duty Service”, as shown (at least embodying herein the step of certifying such at least one antifreeze as meeting ASTM D 3306—“Standard Specification for Glycol Base Engine Coolant for Automobile and Light-Duty Service”). Preferably, method 210 further comprises the step of certifying (step 282) antifreeze 174 as meeting ASTM D 2610—“Standard Specification for Fully-Formulated Glycol Base Engine Coolant for Heavy-Duty Engines”, as shown (at least embodying herein the step of certifying such at least one antifreeze as meeting ASTM D 2610—“Standard Specification for Fully-Formulated Glycol Base Engine Coolant for Heavy-Duty Engines”).

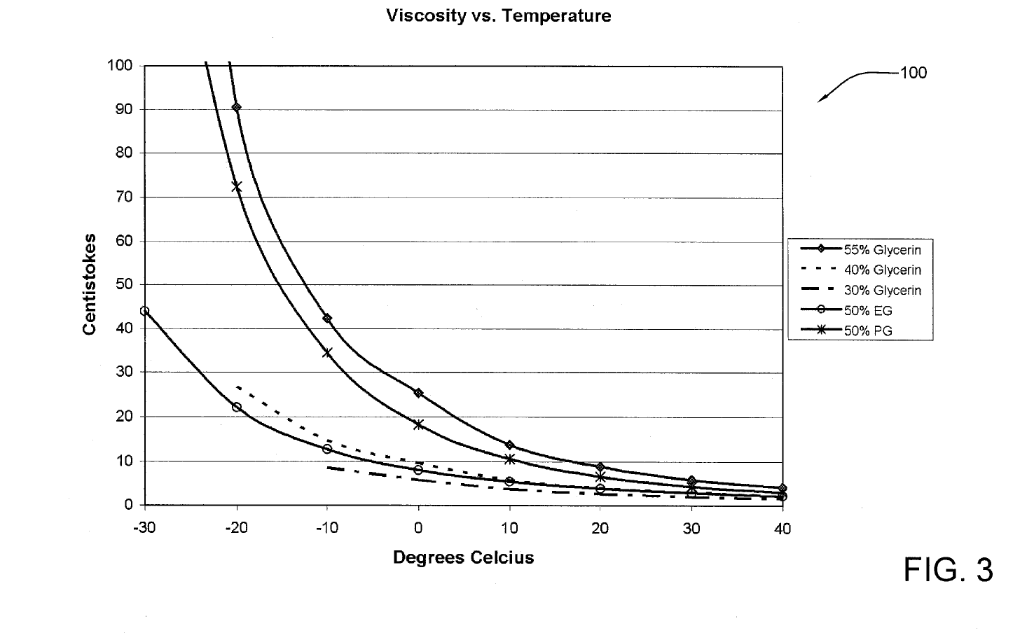

Referring now to FIG. 3 and FIG. 2, it is shown that the viscosity of antifreeze 174 at a particular temperature is a function of the proportion of water 176 to glycerin 170 in antifreeze 174. The viscosity of antifreeze 174 at a particular temperature is adjustable by adjusting the proportion of water 176 to glycerin 170 in antifreeze 174, as shown. The viscosity vs. temperature data for 55%/45% glycerin/water, 40%/60% glycerin/water, and 30%/70% glycerin/water, all of which are preferred embodiments of antifreeze 174, are shown. Automobile and diesel engines are designed to tolerate the viscosity of 50% propylene glycol based antifreeze (shown as 50% PG in FIG. 3). However, automobile and diesel engines perform better with the lower viscosity 50% ethylene glycol based antifreeze (shown as 50% EG in FIG. 3) due to the improved wetting and anticavitation properties of lower-viscosity fluids. Depending on the freezing point required for a particular batch of antifreeze 174, the viscosity of antifreeze 174 can be lowered to the preferred low viscosity of 50% ethylene glycol based antifreeze or lower. This is a surprising experimental result given the high viscosity of pure glycerin. Pure glycerin would be too viscous for unmodified automotive and diesel engines.

Preferably, method 210 further comprises the step of adjusting (step 290) the viscosity of such at least one antifreeze 174 to between the viscosity of at least one propylene-glycol-based antifreeze (defined herein as about 50% propylene glycol/50% water by volume) and the viscosity of at least one ethylene-glycol-based antifreeze (defined herein as about 50% ethylene glycol/50% water by volume), as shown (at least embodying herein the step of adjusting the viscosity of such at least one antifreeze to between the viscosity of at least one propylene-glycol-based antifreeze and the viscosity of at least one ethylene-glycol-based antifreeze). Preferably, adjusting 290 comprises adding water 176 to glycerin 170 (or vice versa) to generate antifreeze 174 having a viscosity between the viscosity of propylene-glycol-based antifreeze and the viscosity of ethylene-glycol-based antifreeze, as shown.

Preferably, method 210 further comprises the step of approximately matching (step 292) the viscosity of antifreeze 174 to the viscosity of propylene-glycol-based antifreeze, as shown (at least embodying herein the step of approximately matching the viscosity of such at least one antifreeze to the viscosity of at least one propylene-glycol-based antifreeze). Preferably, antifreeze 174 is adapted to comprise about the viscosity of propylene-glycol-based antifreeze comprises antifreeze 293. Preferably, glycerin system 100 comprises antifreeze 293. Antifreeze 293 advantageously has a viscosity that knowledgeable consumers are familiar with which will help overcome consumer reluctance to use unfamiliar antifreeze 293. Further, antifreeze 293 is compatible with automobile engines without any engine modification being required.

Preferably, method 210 further comprises the step of approximately matching (step 294) the viscosity of antifreeze 174 to the viscosity of ethylene-glycol-based antifreeze, as shown (at least embodying herein the step of approximately matching the viscosity of such at least one antifreeze to the viscosity of at least one ethylene-glycol-based antifreeze). Preferably, antifreeze 174 is adapted to comprise about the viscosity of ethylene-glycol-based antifreeze comprises antifreeze 295. Preferably, glycerin system 100 comprises antifreeze 295. Antifreeze 295 advantageously has a viscosity that knowledgeable consumers are familiar with which will help overcome consumer reluctance to use unfamiliar antifreeze 295. Further, antifreeze 295 is compatible with automobile engines without any engine modification being required. Antifreeze 293 is usable in colder environments than antifreeze 295 can be used in.

FIG. 3 shows a diagram illustrating the viscosities of glycerin 170, ethylene glycol, and propylene glycol in water 176 mixtures.

Preferably, glycerin system 100 comprises glycerin antifreeze. Preferably, glycerin antifreeze comprises glycerin from any source, manufactured by any method. More preferably, glycerin antifreeze comprises biodiesel-derived glycerin 170 (at least embodying herein an antifreeze, wherein such glycerin comprises biodiesel-derived glycerin).

Preferably, glycerin antifreeze (at least embodying herein an antifreeze, adapted to have a viscosity between the viscosity of 50% ethylene glycol antifreeze and the viscosity of 50% propylene glycol antifreeze, comprising glycerin) is adapted to have a viscosity between the viscosity of 50% ethylene glycol antifreeze and the viscosity of 50% propylene glycol antifreeze at 0 degrees Celsius. Preferably, glycerin antifreeze comprises at least 20% glycerin by volume.

In an alternative preferred embodiment, glycerin antifreeze is adapted to have about the viscosity of 50% ethylene glycol based antifreeze (at least embodying herein an antifreeze adapted to have the viscosity of 50% ethylene glycol based antifreeze). In another alternative preferred embodiment, glycerin antifreeze is adapted to have about the viscosity of 50% propylene glycol based antifreeze (at least embodying herein an antifreeze adapted to have the viscosity of 50% propylene glycol based antifreeze). Further, glycerin antifreeze is compatible with automobile engines without any engine modification being required.

Experimental Data

The following experimental data describes one particular embodiment of antifreeze 174.

An experimental fluid (comprising one particular embodiment of antifreeze 174) was blended as follows:
55% v/v Bi-Pro Glycerin (a renewable resource product), manufactured using the preferred methods described herein by Bi-Pro located in Guelph, Ontario, Canada
43.8% v/v deionized water
1.1% v/v fully formulated conventional antifreeze additive

Such experimental fluid hereinafter referred to as “Experimental Fluid A”.

TABLE 1
Sample Analytical Identification of Experimental Fluid A

| Test performed | This sample |
|---|---|
| Color and Appearance* | Green & Clear |
| Boron (mg/l B) by ASTM D6130 | 184 |
| Molybdenum (mg/l Mo) by ASTM D6130 | 0 |
| Nitrites (mg/l) by ASTM D5827 | 1375 |
| Nitrates (mg/l) by ASTM D5827 | 434 |
| Phosphate (mg/l) by ASTM D5827 | 0 |
| Silicon (mg/l Si) by ASTM D6130 | 111 |
| Chloride (mg/l) by ASTM D5827 | 12 |
| Sulfate (mg/l) by ASTM D5827 | 0 |

TABLE 2
Physical and Chemical Tests of Experimental Fluid A

| | | ASTM D3306 |
|---|---|---|
| Test Number & Description | Test Result | accepted value |
| ASTM D1122 Relative | 1.1485 | 1.110-1.145 |
| Density | | |
| ASTM D1177 Freeze Point | −37° C. (−34 C) | −37° C. |
| | | (−34° F.) max. |
| ASTM D1120 Boiling Point | 108.5° C. (227° F.) | 108° C. (226° F.) |
| | | minimum |
| ASTM D1882 Auto Finish | No effect | No effect |
| Effect | | |
| ASTM D1119 Ash Content | 0.9% | 5.0% max. |
| ASTM D1287 pH: 50% vol. | 0.61 | 7.5 to 11.0 |
| in distilled water | | |
| ASTM D1121 Reserve | 3.6 ml | N/A |
| Alkalinity | | |
| ASTM D1881 Foaming | 1.8 sec | Break: 5 sec. |
| Tendencies | 60 ml | Volume: 150 ml |

The above physical and chemical tests show that Sample A meets all the tested ASTM standards.

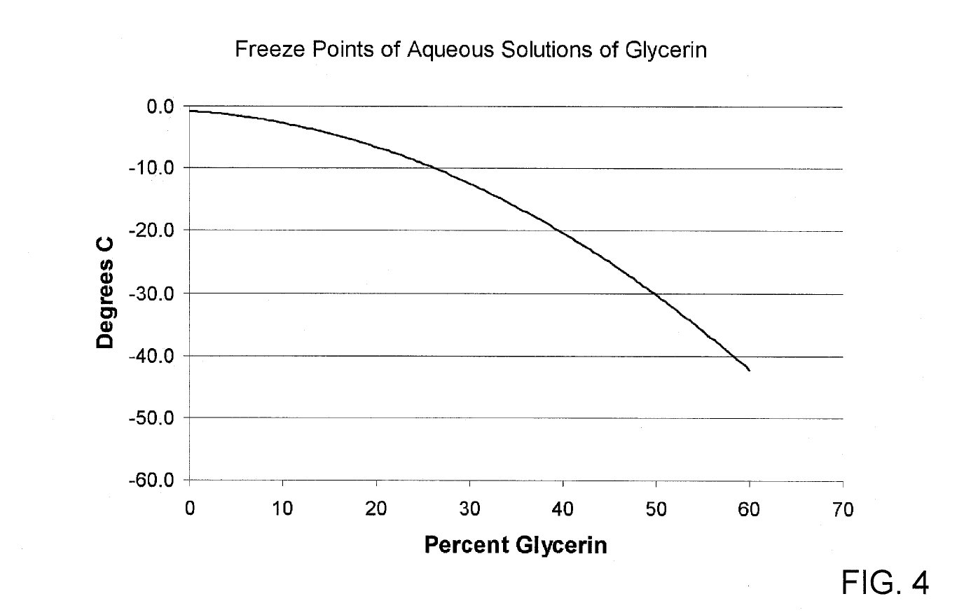

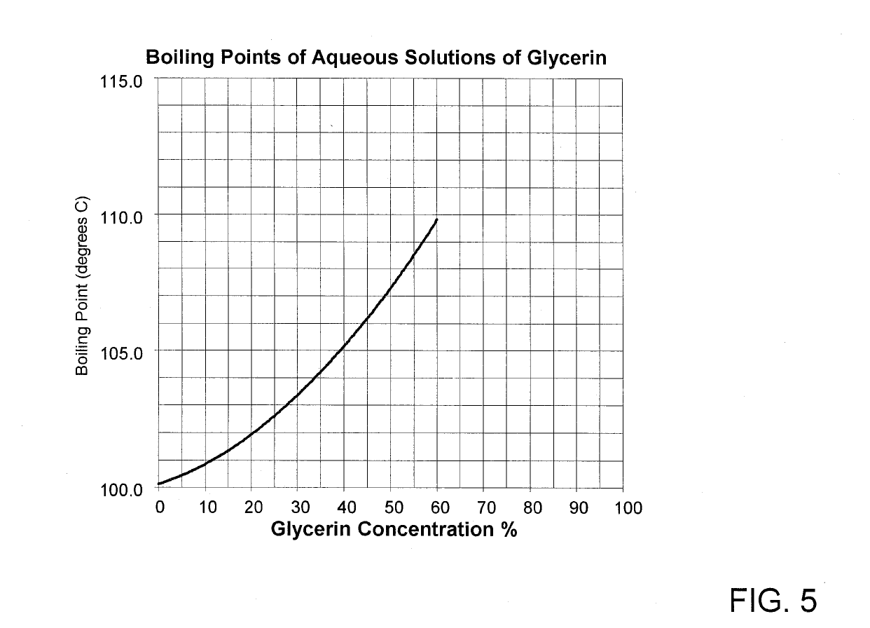

The boiling point and freezing point for aqueous solutions of various Bi-Pro glycerin concentrations, such glycerin manufactured using the preferred methods described herein, by Bi-Pro located in Guelph, Ontario, Canada was performed by ASTM D1120—“Standard Test Method for Boiling Point of Engine Coolants” and ASTM D1177—“Standard Test Method for Freezing Point of Aqueous Engine Coolants”, respectively. Six different concentrations of glycerin ranging from 10% glycerin to 60% glycerin were tested. Seven different concentrations of glycerin ranging from 10% to 60% glycerin, including 55% glycerin, were tested. As the concentration of glycerin in an aqueous solution is increased, the freezing point of the resulting solution is lowered. See Table 3 and FIG. 4. Also, as the concentration of glycerin in an aqueous solution is increased, the boiling point of the resulting solution is raised. See Table 4 and FIG. 5.

TABLE 3
Freezing Points of Aqueous Solutions of Glycerin

| | % of Glycerin | | | | | | |
|---|---|---|---|---|---|---|---|
| | 0 | 10 | 20 | 30 | 40 | 50 | 60 |
| Freeze Point by ASTM | 32.0 | 25.1 | 20.0 | 10.1 | −4.2 | −21.6 | −44.8 |
| D1177 (° Fahrenheit) | | | | | | | |
| Freeze Point by ASTM | 0.0 | −3.8 | −6.7 | −12.2 | −20.1 | −29.8 | −42.7 |
| D1177 (° Celsius) | | | | | | | |

TABLE 4
Boiling Points of Aqueous Solutions of Glycerin

| | % of Glycerin | | | | | | | |
|---|---|---|---|---|---|---|---|---|
| | 0 | 10 | 20 | 30 | 40 | 50 | 55 | 60 |
| Boiling | 100.0 | 100.9 | 102.2 | 103.4 | 104.9 | 107.2 | 108.5 | 110.0 |
| Point by | | | | | | | | |
| ASTM | | | | | | | | |
| D1120 | | | | | | | | |
| (° Celsius) | | | | | | | | |

ASTM D4340—“Corrosion of Heat-Rejecting Aluminum Surfaces”

To determine whether or not Experimental Sample A would contribute to corrosion of aluminum which is typically found in aluminum cylinder heads, testing of Experimental Sample A using the ASTM D4340 standard was performed. The ASTM D4340 test method covers a laboratory screening procedure for evaluating the effectiveness of engine coolants in combating corrosion of aluminum casting alloys under heat-transfer conditions that may be present in aluminum cylinder head engines.

In the ASTM D4340 test method, a heat flux is established through a cast aluminum alloy typical of that used for engine cylinder heads while exposed to an engine coolant under a pressure of 193 kPa (28 psi). The temperature of the aluminum specimen is maintained at 135° C. (275° F.) and the test is continued for 1 week (168 h). The effectiveness of the coolant for preventing corrosion of the aluminum under heat-transfer conditions (hereafter referred to as heat-transfer corrosion) is evaluated on the basis of the weight change of the test specimen.

TABLE 5
ASTM D4340 Test Results of Experimental Sample A

| Run #1 | Run #2 | Average | ASTM |
|---|---|---|---|
| Weight Loss | Weight Loss | Weight Loss | Limit* |
| (mg/cm²/wk) | (mg/cm²/wk) | (mg/cm²/wk) | (mg/cm²/wk) |
| 0.06 | 0.08 | 0.07 | 1.00 |
| pH after (1) | pH after (2) | Appearance | |

| | | |
|---|---|---|
| 6.44 | 6.42 | Surfaces were dark, |
| | | undamaged and had very light |
| | | deposits, probably silicate. |

*Limits published in ASTM D3306 Standard Specification for Glycol Base Engine Coolant for Automobile and Light-Duty Service. These performance limits are also required for heavy-duty coolants and recycled coolants (ASTM D6471 or D6472). ASTM D4340 is only a test method, the pass/fail criteria are not defined therein.
A negative number indicates a net weight gain after correcting for the cleaning blank. Refer to the published method for information on the calculations.

ASTM D2809—“Cavitation Corrosion and Erosion-Corrosion Characteristics of Aluminum Pumps With Engine Coolants”

To test the potential cavitation corrosion with Experimental Sample A, testing under ASTM D2809 was performed as follows. The ASTM D2809 test method consists of pumping an aqueous coolant solution at 113° C. (235° F.) through a pressurized 103-kPa (15-psig) simulated automotive coolant system. An aluminum automotive water pump, driven at 4600 r/min by an electric motor, is used to pump the solution and to serve as the object specimen in evaluating the cavitation erosion corrosion effect of the coolant under test. The pump is examined to determine the extent of cavitation erosion corrosion damage and is rated according to the system given in Table 6.

The ASTM D2809 test method can be used to distinguish between coolants that contribute to cavitation corrosion and erosion corrosion of aluminum automotive water pumps and those that do not. It is not intended that a particular rating number, as determined from this test, will be equivalent to a certain number of miles in a vehicle test; however, limited correlation between bench and field service tests has been observed with single-phase coolants. Field tests under severe operating conditions should be conducted as the final test if the actual effect of the coolant on cavitation corrosion and erosion-corrosion is to be appraised. It is also possible, with proper control of the test variables, to determine the effect of pump design, materials of construction, and pump operating conditions on cavitation.

TABLE 6
ASTM D2809 Rating System

| | |
|---|---|
| 10 | No corrosion or erosion present; no metal loss. No change from original casting |
| | configuration. Staining permitted. |
| 9 | Minimal corrosion or erosion. Some rounding of sharp corners or light smoothing or |
| | both, or polishing of working surfaces. |
| 8 | Light corrosion or erosion may be generalized on working surfaces. Dimensional change |
| | not to exceed 0.4 mm (164 in.). |
| 7 | Corrosion or erosion with dimensional change not to exceed 0.8 mm (132 in.). Random |
| | pitting to 0.8 mm permitted. |
| 6 | Corrosion or erosion with dimensional change not to exceed 0.8 mm. Depressions, |
| | grooves, clusters of pits, or scalloping, or both, within 0.8 mm dimensional change limit |
| | permitted. |
| 5 | Corrosion or erosion with dimensional change not to exceed 1.6 mm (116 in.). Small |
| | localized areas of metal removal in high-impingement regions or random pits to 1.6 mm |
| | permitted. |
| 4 | Corrosion or erosion with dimensional change not to exceed 1.6 mm. Small localized |
| | areas of metal removal in high-impingement regions, clusters of pits within 1.6 mm |
| | dimensional change. Random pits to 2.4 mm (332 in.) permitted. |
| 3 | Corrosion or erosion with dimensional change not to exceed 2.4 mm. Depressions, |
| | grooves, clusters of pits or scalloping, or both, permitted. |
| 2 | Corrosion or erosion with any dimensional change over 2.4 mm, and short of pump case |
| | failure |
| 1 | Pump case leaking due to corrosion or erosion. |

TABLE 7
ASTM D 2809 Test Results of Experimental Sample A

| Pump Rating | Solution pH |
|---|---|
| 9 | Start: 9.63 |
| | End: 7.82 |

Note:
ASTM D-3306 requires a pump rating of 8 or higher on a scale of 10.

After testing of Experimental Sample A was performed it was observed that the pump was nearly undamaged. Only a single point of attack at the location of the water pump impeller part number was observed. Further, the observed damage was slight, measuring 0.28 mm in depth.

ASTM D1384—“Corrosion Test for Engine Coolants in Glassware”

To determine the corrosion capability of Experimental Sample A in glassware, testing under ASTM D1384 standard was performed. The ASTM D1384 standard test method covers a simple beaker-type procedure for evaluating the effects of engine coolants on metal specimens under controlled laboratory conditions. Specimens of metals typical of those present in engine cooling systems are totally immersed in aerated engine coolant solutions prepared with corrosive salts for 336 hours at 88° C. (190° F.). The corrosion inhibition properties of the test solution are evaluated on the basis of the weight changes incurred by the specimens. Each test is run in triplicate, and the average weight change is determined for each metal. This test method will generally distinguish between coolants that are definitely deleterious from the corrosion standpoint and those that are suitable for further evaluation. However, the results of this test method cannot stand alone as evidence of satisfactory corrosion inhibition. Only more comprehensive bench, dynamometer, and field tests can determine the actual service value of an engine coolant formulation.

Automobile manufacturers have accepted the specimens prescribed in this test method, but their composition may not be the same as that of alloys currently used for engine cooling system components. Therefore, specimens other than those designated in this test method may be used by mutual agreement of the parties involved. The following metal test specimens, 1 by 2 inches in size, representative of cooling system metals, were used:
1. Steel, UNS G10200 (SAE 1020), Chemical composition of the carbon steel is as follows: carbon, 0.17 to 0.23%; manganese, 0.30 to 0.60%; phosphorus, 0.040% maximum; sulfur, 0.050% maximum.
2. Copper, conforming to UNS C11000 (SAE CA110) or UNS C11300 (SAE CA113). Cold-rolled.
3. Brass, conforming to Alloy UNS C26000 (SAE CA 260).
4. Solder, A brass specimen as described in 6.1.3, coated with solder conforming to Alloy Grade 30A (SAE 3A)
5. Cast Aluminum, conforming to Alloy UNS A23190 (SAE 329).
6. Cast Iron, conforming to Alloy UNS F10007 (SAE G3500).

TABLE 8
ASTM D1384 Test Data of Experimental Sample A

| | | | | | ASTM |
|---|---|---|---|---|---|
| Metal | 1^{st} | 2^{nd} | 3^{rd} | Average | Limit* |
| Copper | 4 | 4 | 3 | 4 | 10 |
| Solder | 1 | 1 | 1 | 1 | 30 |
| Brass | 2 | 2 | 2 | 2 | 10 |
| Steel | 1 | 0 | 1 | 1 | 10 |
| Iron | 1 | 0 | 2 | 1 | 10 |
| Aluminum | −1 | −2 | −1 | −1 | 30 |

*Limits published in ASTM D3306 Standard Specification for Glycol Base Engine Coolant for Automobile and Light-Duty Service. These performance limits are also required for heavy-duty coolants and recycled coolants (ASTM D6471 or D6472). D1384 is only a test method.
A negative number indicates a net weight gain after correcting for the cleaning blank. (Refer to the published method for information on the calculations).

D2570 “Simulated Service Corrosion Testing of Engine Coolants”

A simulated service test of Experimental Sample A was performed according to ASTM D2570. The ASTM D2570 standard test method evaluates the effect of a circulating engine coolant on metal test specimens and automotive cooling system components under controlled, essentially isothermal laboratory conditions. This test method specifies test material, cooling system components, type of coolant, and coolant flow conditions that are considered typical of current automotive use. An engine coolant is circulated for 1064 hours at 190° F. (88° C.) in a flow loop consisting of a metal reservoir, an automotive coolant pump, an automotive radiator, and connecting rubber hoses. Test specimens representative of engine cooling system metals are mounted inside the reservoir, which simulates an engine cylinder block. At the end of the test period, the corrosion-inhibiting properties of the coolant are determined by measuring the mass losses of the test specimens and by visual examination of the interior surfaces of the components. This test method, by a closer approach to engine cooling system conditions, provides better evaluation and selective screening of engine coolants than is possible from glassware testing (Test Method ASTM D1384). The improvement is achieved by controlled circulation of the coolant, by the use of automotive cooling system components, and by a greater ratio of metal surface area to coolant volume.

TABLE 9
ASTM D2570 Test Results for Experimental Sample A
Specimen Corrosion Weight Loss (mg)

| Specimen | #1 | #2 | #3 | Avg. | Max |
|---|---|---|---|---|---|
| Copper | 3 | 4 | 3 | 3 | 20 |
| 30a Solder | 9 | 8 | 8 | 8 | 60 |
| Brass | 0 | 0 | 1 | 1 | 20 |
| Steel | 1 | 1 | 1 | 1 | 20 |
| Cast Iron | 1 | 0 | 1 | 1 | 20 |
| Cast Aluminum | −1 | 0 | 0 | 0 | 60 |

| | pH | RA | Appearance |
|---|---|---|---|
| Before D2570 | 9.55 | 8.18 | All exposed parts were in very good |
| After D2570 | 2.3 | 2.7 | condition following the testing. |

| Part Name | New | Manufacturer | Part # |
|---|---|---|---|
| Pump, Cast A1 | Y | GM | 10120945 |
| Radiator: Copper, | Y | GM | 3056740 |
| Brass, Lead/Tin Solder | | | |
| Hoses | Y | Gates | 1 3/16″ Heavy Duty |
| Reservoir | Y | Commercial | D2570 Cast Iron |
| | | Machine Works | |
| Motor | N | Dayton | 3N748 |

To test the use of an experimental sample of antifreeze comprising additive packs, the below testing was performed.

The following experimental blend was made and tested
55% v/v Bi-pro glycerin
41.5% v/v deionized water
3.5% v/v Nitrite, Molybdate Organic Acid Technology Fully Formulated Extended

Service Interval Coolant

Such experimental sample hereinafter referred to as Experimental Sample B.

Experimental Sample B was tested according to ASTM D6210-04 and ASTM D3306-03 standards. Blendtech Nitrite, Molybdate Organic Acid Technology Fully Formulated Extended Service Interval Coolant (“NMOAT”), made available by Blendtech Inc., of Lake Tahoe, Nev., was added to glycerin to and water as shown above to make Experimental Sample B and tested according to ASTM D6210-04, ASTM D3306, and TMC RP 329 and TMC RP 330 standards.

ASTM D6210-04—“Standard Specification for Fully-Formulated Glycol Base Engine Coolant for Heavy-Duty Engines”

The ASTM D6210-04 specification covers the requirements for fully formulated glycol base coolants for cooling systems of heavy duty engines. When concentrates are used at 40% to 60% glycol concentration by volume in water of suitable quality, or when prediluted glycol base engine coolants (50 volume % minimum) are used without further dilution, they will function effectively during both winter and summer to provide protection against corrosion, cavitation, freezing, and boiling. The ASTM D6210-04 specification is intended to cover the requirements for engine coolants prepared from virgin or recycled ethylene or propylene glycol. The coolants governed by this specification are categorized as follows: I-FF, Ethylene glycol base concentrate; II-FF, Propylene glycol base concentrate; III-FF, Ethylene glycol predilute (50 vol %); and IV-FF, Propylene glycol predilute (50 vol %). In this experimental setup; however, data were generated from using glycerin as antifreeze, an experimental base fluid considered to be a possible alternative to the traditional glycols.

Coolant concentrates meeting the requirements of the ASTM D6210-04 specification do not require any addition of Supplemental Coolant Additive (hereinafter referred to as “SCA”) until the first maintenance interval when a maintenance dose of SCA is required to continue protection in certain heavy duty engine cooling systems, particularly those of the wet cylinder liner-in-block design. The SCA additions are defined by and are the primary responsibility of the engine manufacturer or vehicle manufacturer. If they provide no instructions, the SCA supplier's instructions should be followed.

The concentrated and prediluted coolants tested shall meet all of the respective requirements of ASTM D3306 specification. The coolant concentrate mixed with water or the prediluted coolant, when maintained with maintenance doses of SCA in accordance with the engine manufacturer's recommendations, and those on the product label, shall be suitable for use in a properly maintained cooling system in normal service for a minimum of two years

The coolant concentrate or prediluted coolant additionally shall provide protection in operating engines against cavitation corrosion (also termed liner pitting) and against scaling of internal engine hot surfaces. Hot surfaces typically are within the engine head, head spacer, upper cylinder liner, or liquid cooled exhaust manifold.

Laboratory data or in-service experience demonstrating a positive influence on reducing cavitation corrosion in an operating engine is required. In-service qualification tests may consist of single or multiple-cylinder engine tests. At the option of the engine or vehicle manufacturer, such testing may be conducted in “loose engines” or in engines fully integrated into an application, such as a vehicle, a power boat, or a stationary power source. One such test has been developed (the John Deere engine cavitation test). Several chemical compositions have been tested extensively by producers and users and satisfactorily minimize cylinder liner cavitation in actual test engines. Coolants meeting either of the following compositions are regarded as passing the requirements of D6210:
1. A minimum concentration of nitrite (as NO₂⁻) of 1200 ppm in the 50 volume % predilute coolant, or
2. A minimum combined concentration of nitrite (as NO₂⁻) plus molybdate (as MoO₄⁻²) in the 50-volume % predilute coolant of 780 ppm. At least 300 ppm each of NO₂− and MoO4-2 must be present.

The above concentrations are doubled for coolant concentrates.

Both concentrated and prediluted coolants under this specification must contain additives to minimize hot surface scaling deposits. Certain additives (polyacrylate and other types) minimize the deposition of calcium and magnesium compounds on heat rejecting surfaces. No specific chemical requirements for hot surface scaling and deposits resistance have been established at this time. A test procedure is under development and will be incorporated into the specification when ASTM approves a procedure.

The D3306 and D6210 specifications publish the following requirements for the physical and chemical tests:

| | | | | | Test |
|---|---|---|---|---|---|
| | EG | PG | EG | PG | Method |
| Property | Concentrate | Concentrate | Predilute | Predilute | used |
| Relative Density, | 1.110-1.145 | 1.030-1.065 | 1.065 min. | 1.025 min. | D1122 |
| 15.5/15.5° C. | | | | | |
| (60/60° F.) | | | | | |
| Freezing Point, ° C. | −37 (−34) | −32 (−26) | −37 (−34) | −32 (−26) | D1177 |
| (° F.) 50% in DI water | max. | max. | max. | max. | |
| Undiluted | | | | | |
| Boiling Point° C. | 108 (226) | 104 (219) | 108 (226) | 104 (219) | D1120 |
| (° F)^{A} | min | min | min | min | |
| 50% in DI water, | 163 (325) | 152 (305) | | | |
| Undiluted | min | min | | | |
| Ash content, mass % | 5 max. | 5 max. | 5 max. | 5 max. | D1119 |
| pH 50 vol % in DI water | 7.5-11.0 | 7.5-11.0 | 7.5-11.0 | 7.5-11.0 | D1287 |
| Undiluted | | | | | |
| Chloride, ppm | 25 max | 25 max | 25 max | 25 max | D5827 |
| Sulfate, ppm | 50 max | 50 max | 50 max | 50 max | D5827 |
| Water, mass % | 5 max. | 5 max. | 5 max. | 5 max. | D1123 |
| Reserve Alkalinity, | report | report | report | report | D1121 |
| ml^{B} | | | | | |
| Effect on Automotive | no effect | no effect | no effect | no effect | D1882 |
| Finish^{C} | | | | | |

^{A}Some precipitate may be observed at the end of the test. This is not a cause for rejection.
^{B}Value as agreed between customer and supplier.
^{C}Procedure and acceptance criteria should be agreed between customer and supplier

Experimental Sample B has the chemical profile listed below in Table 10:

TABLE 10
Experimental Sample B Analytical Identification

| | |
|---|---|
| Test performed | This sample |

Physical Data

| | |
|---|---|
| Color and Appearance* | N/A |
| pH by ASTM D1287 | |
| % Antifreeze from chart* | 100 |
| Freezing Point² by ASTM D1177 | −34 |

Corrosion Inhibitors

| | |
|---|---|
| Boron (mg/l B) ASTM D 6130 | 0 |
| Molybdenum (mg/l Mo) ASTM D 6130 | 265 |
| Nitrites (mg/l) by ASTM D 5827 | 400 |
| Nitrates (mg/l) by ASTM D 5827 | 0 |
| Phosphate (mg/l) by ASTM D 5827 | 0 |
| Silicon (mg/l Si) by ASTM D 6130 | 0 |

Age and Wear Indicators

| | |
|---|---|
| Aluminum (mg/l Al) ASTM D 6130 | 0 |
| Calcium (mg/l Ca) ASTM D 6130 | 0 |
| Chloride (mg/l) ASTM D 5827 | 3 |
| Copper (mg/l Cu) ASTM D 6130 | 0 |
| Formate (mg/l) glycol degradation acid* | 0 |
| Glycolate (mg/l) glycol degradation acid* | 0 |
| Iron (mg/l Fe) ASTM D 6130 | 0 |
| Magnesium (mg/l Mg) ASTM D 6130 | 0 |
| Lead (mg/l Pb) ASTM D 6130 | 0 |
| Sulfate (mg/l) ASTM D 5827 | 0 |

Azoles and Carboxylates by HPLC

| | |
|---|---|
| Mercaptobenzothiazole mg/l* | 0 |
| Benzotriazole mg/l* | 0 |
| Tolyltriazole mg/l* | 100 |
| Benzoate mg/l* | 0 |
| 2 Ethylhexanoic acid mg/l* | 17500 |
| Sebacic acid mg/l* | 0 |

TABLE 11
ASTMD3306 Physical & Chemical Tests for Experimental Sample B

| Test Number & Description | Test Result |
|---|---|
| ASTM D1122 Relative Density (aka | 1.1543 |
| Specific Gravity) | |
| ASTM D1177 Freeze Point ° C. (° F.) | −36.7 (−34.0) |
| 50% with 50% DI Water v/v | |
| ASTM D1120 Boiling Point ° C. (° F.) | 108.0 (226.4) |
| 50% with 50% DI Water v/v | |
| ASTM D1882 Auto Finish Effect | No effect |
| ASTM D1119 Ash Content, mass % | 1.06% |
| ASTM D1287 pH: 50% vol. in distilled | 8.0 |
| water | |
| ASTM D3634 Chloride ppm | 3 |
| D-1121 Reserve Alkalinity ML | 1.4 ml |
| D-1881 Foaming Tendencies | 230 ml volume |
| | 4.6 seconds break time |

ASTM D4340—“Corrosion of Cast Aluminum Alloys in Engine Coolants Under Heat-Rejecting Conditions”

The ASTM D4340 test method covers a laboratory screening procedure for evaluating the effectiveness of engine coolants in combating corrosion of aluminum casting alloys under heat-transfer conditions that may be present in aluminum cylinder head engines.

In this test method, a heat flux is established through a cast aluminum alloy typical of that used for engine cylinder heads while exposed to an engine coolant under a pressure of 193 kPa (28 psi). The temperature of the aluminum specimen is maintained at 135° C. (275° F.) and the test is continued for 1 week (168 h). The effectiveness of the coolant for preventing corrosion of the aluminum under heat-transfer conditions (hereafter referred to as heat-transfer corrosion) is evaluated on the basis of the weight change of the test specimen.

TABLE 12
ASTM D 4340 Test Results for Experimental Sample B

| | Run #1 | Run #2 | Average |
|---|---|---|---|
| Weight Loss | 0.08 | 0.06 | 0.07 |
| (mg/cm²/wk) | | | |
| pH After | 6.76 | 6.75 | |

Notes:
ASTM places the maximum corrosion rate at 1.00 (mg/cm²/wk).

ASTM D1384—“Corrosion Test for Engine Coolants in Glassware”

This test method covers a simple beaker-type procedure for evaluating the effects of engine coolants on metal specimens under controlled laboratory conditions. In this test method, specimens of metals typical of those present in engine cooling systems are totally immersed in aerated engine coolant solutions prepared with corrosive salts for 336 hours at 88° C. (190° F.). The corrosion inhibition properties of the test solution are evaluated on the basis of the weight changes incurred by the specimens. Each test is run in triplicate, and the average weight change is determined for each metal. This test method will generally distinguish between coolants that are definitely deleterious from the corrosion standpoint and those that are suitable for further evaluation. However, the results of this test method cannot stand alone as evidence of satisfactory corrosion inhibition. Only more comprehensive bench, dynamometer, and field tests can determine the actual service value of an engine coolant formulation.

Automobile manufacturers have accepted the specimens prescribed in this test method, but their composition may not be the same as that of alloys currently used for engine cooling system components. Therefore, specimens other than those designated in this test method may be used by mutual agreement of the parties involved. The following metal test specimens, 1 by 2 inches in size, representative of cooling system metals, were used:
7. Steel, UNS G10200 (SAE 1020), Chemical composition of the carbon steel is as follows: carbon, 0.17 to 0.23%; manganese, 0.30 to 0.60%; phosphorus, 0.040% maximum; sulfur, 0.050% max.
8. Copper, conforming to UNS C1000 (SAE CA10) or UNS C11300 (SAE CA113). Cold-rolled.
9. Brass, conforming to Alloy UNS C26000 (SAE CA 260).
10. Solder, A brass specimen as described in 6.1.3, coated with solder conforming to Alloy Grade 30A (SAE 3A)
11. Cast Aluminum, conforming to Alloy UNS A23190 (SAE 329).
12. Cast Iron, conforming to Alloy UNS F10007 (SAE G3500).

TABLE 13
ASTM D 1384 Test Results for Experimental Sample B

| | Specimen Corrosion | | | | |
|---|---|---|---|---|---|
| ASTM D1384 | Weight Loss (mg) | | | | |
| Specimen | #1 | #2 | #3 | Avg | Max* |
| Copper | 1 | 2 | 3 | 2 | 10 |
| Solder | 2 | 6 | 4 | 4 | 30 |
| Brass | 1 | 2 | 1 | 1 | 10 |
| Steel | 1 | 1 | 2 | 1 | 10 |
| Cast Iron | 1 | 2 | 2 | 2 | 10 |
| Cast Aluminum | 6 | 3 | 4 | 4 | 30 |

*Maximum corrosion weight loss as specified by ASTM D3306

ASTM D2570—“Simulated Service Corrosion Testing of Engine Coolants”

This test method evaluates the effect of a circulating engine coolant on metal test specimens and automotive cooling system components under controlled, essentially isothermal laboratory conditions. This test method specifies test material, cooling system components, type of coolant, and coolant flow conditions that are considered typical of current automotive use. An engine coolant is circulated for 1064 h at 190° F. (88° C.) in a flow loop consisting of a metal reservoir, an automotive coolant pump, an automotive radiator, and connecting rubber hoses. Test specimens representative of engine cooling system metals are mounted inside the reservoir, which simulates an engine cylinder block. At the end of the test period, the corrosion-inhibiting properties of the coolant are determined by measuring the mass losses of the test specimens and by visual examination of the interior surfaces of the components. This test method, by a closer approach to engine cooling system conditions, provides better evaluation and selective screening of engine coolants than is possible from glassware testing (Test Method D 1384). The improvement is achieved by controlled circulation of the coolant, by the use of automotive cooling system components, and by a greater ratio of metal surface area to coolant volume. Although this test method provides improved discrimination, it cannot conclusively predict satisfactory corrosion inhibition and service life. If greater assurance of satisfactory performance is desired, it should be obtained from full-scale engine tests and from field-testing in actual service. The same coupons used in D1384 are also used in this test.

TABLE 14
ASTM D 2570 Test Results for Experimental Sample B
Specimen Corrosion Weight Loss (mg)

| Specimen | #1 | #2 | #3 | Avg. | Max* |
|---|---|---|---|---|---|
| Copper | 3 | 3 | 3 | 3 | 20 |
| 30a Solder | 11 | 11 | 9 | 10 | 60 |
| Brass | 4 | 3 | 4 | 4 | 20 |
| Steel | 1 | 1 | 2 | 1 | 20 |
| Cast Iron | 5 | 6 | 6 | 5 | 20 |
| Cast Aluminum | 0 | 2 | 1 | 1 | 60 |

| | pH | RA | Appearance |
|---|---|---|---|
| Before D2570 | 7.79 | 1.3 | All exposed parts were in very good |
| After D2570 | 7.40 | 1.2 | condition following the testing. |

*Maximum corrosion weight loss as specified by ASTM D3306

Scaling Resistance of Engine Coolants on Hot Steel Surfaces

This test method circulates coolant at 190 degrees F. pas a stainless steel heater rod that is heated to 400 degrees F. for 96 hours. The test fluid may be engineered to contain hard water minerals or other hot surface depositing species. At the conclusion of the 96-hour exposure the heater rod is removed and dried. The weight of deposit is determined by comparing the weight of the prepared rod before exposure, and after.

Development of this test method is published as “Scale and Deposits in High Heat Rejecting Engines”, Engine Coolant Testing, Fourth Volume, STP 1335, ASTM International, 100 Barr Harbor Drive, West Conshohoshocken, Pa. 19428.

TABLE 14
Scaling Test Results for Experimental Sample B

| Weight | Weight | Net |
|---|---|---|
| Before Exposure | After Exposure | Weight Change |
| (g) | (g) | (g) |
| 294.487 | 295.691 | 1.204 |

A negative number reflects a weight loss.

Performance in this test is by agreement between Supplier and Customer. There is not, as yet, any industry standard for pass/fail in hot surface scale testing.

Stability Testing of Experimental Sample by Adapted GM 6277M Standard

The test method described below is adapted from GM 6277M, “Coolant—Extended Life Automotive, Concentrate—Ethylene Glycol” paragraphs 3.12.1 “Storage Stability of Concentrate”, 3.12.2 “Hot Storage Stability of Concentrate”, and 3.12.3 “Storage Stability of 50 Volume % Dilution”. The published GM 6277M test methods for ensuring stability requirements are as follows:

GM 6277M Section 3.12.1 Storage Stability of Concentrate. Allow an undiluted sample of the candidate coolant to stand for 24 h. Any separation into phases shall disqualify the candidate engine coolant. The test shall be repeated using a 1:1 volumetric mixture of the candidate coolant with a coolant previously approved to GM6277M.

GM 6277M Section 3.12.2 Hot Storage Stability of Concentrate. 100 ml of the candidate coolant concentrate is placed in a 200 ml Erlenmeyer flask, covered with a watch glass and stored for 336 h at 60±2.5° C. After being cooled to room temperature for 30 minutes, the coolant is centrifuged. The precipitate is washed three times with 20 ml portions of methanol, then dried for 2 h at 120° C., cooled to room temperature in a desiccator and weighed. No more than 10 mg of residue is allowed from each 100 ml portion of coolant. The test shall be repeated using a 1:1 volumetric mixture of the candidate coolant with a coolant previously approved to GM6277M.

GM 6277M Section 3.12.3 Storage Stability of 50 Volume % Dilution. Samples of candidate coolant concentrate shall show no separation or precipitation when diluted with hard water and tested as follows. Prepare the hard water by adding 0.275 g of CaCl2 to 1 L of the water described in ASTM D1384. Mix 100 ml of coolant concentrate plus 100 ml of hard water at room temperature in a 250 ml beaker and allow to stand in the dark for 24 h. Make a second mixture, as above, and heat to 82° C. and allow to cool to room temperature and to stand in the dark 24 h. Slight cloudiness is permitted; but formation of a precipitate is considered sufficient to interfere with bulk storage and use of the mixtures.

In the present example, solutions were prepared that contained 0% (control), 25%, 50%, and 75% biodiesel derived glycerin and ethylene glycol or propylene glycol per the GM 6277M standards. The tested fluids were inhibited with recommended concentrations of fully formulated conventional coolant additive (hereinafter sometimes referred to as “FFCA”) based on nitrite, nitrate, borate, and silicate. The experiments were repeated with an extended-life, fully-formulated coolant additive containing nitrite, molybdate, 2-ethylhexanoic acid and tolyltriazole (such extended-life, fully-formulated coolant additive hereinafter sometimes referred to as “NMOAT”). The tested solutions were as follows: Mixture A comprising 25% biodiesel derived glycerin & 75% EG, Mixture B comprising 50% biodiesel derived glycerin & 50% EG, Mixture C comprising 75% biodiesel derived glycerin & 25% EG, and Mixture D comprising 100% EG (serving as a control), Mixture E comprising 25% biodiesel derived glycerin & 75% PG, Mixture F comprising 50% biodiesel derived glycerin & 50% PG, Mixture G comprising 75% biodiesel derived glycerin & 25% PG, and Mixture H comprising 100% PG. The BTFFCA (Blendtech Fully Formulated Conventional Coolant Additive) added was made available by Blendtech Inc., of Lake Tahoe, Nev. The BTNMOAT (Blendtech nitrite, molybdate, 2-ethylhexanoic acid and tolyltriazole extended-life, fully-formulated coolant additive) added was made available by Blendtech Inc., of Lake Tahoe, Nev.

TABLE 15
Biodiesel Derived Glycerin & EG with FFCA

| | 3.121 Storage | 3.122 Hot Storage | 3.123 Storage |
|---|---|---|---|
| | Stability of | Stability of | Stability of 50 |
| Mixture | Concentrate | Concentrate | Volume % Dilution |
| A + BTFFCA | No separation and no | 0 mg | |
| | visible precipitation | | |
| B + BTFFCA | No separation and no | 0 mg | |
| | visible precipitation | | |
| C + BTFFCA | No separation and no | 0 mg | |
| | visible precipitation | | |
| D + BTFFCA | No separation and no | 0 mg | |
| | visible precipitation | | |
| A + BTFFCA mixed | No separation and no | 0 mg | |
| 50/50 with Prestone | visible precipitation | | |
| ELS | | | |
| B + BTFFCA mixed | No separation and no | 0 mg | |
| 50/50 with Prestone | visible precipitation | | |
| ELS | | | |
| C + BTFFCA mixed | No separation and no | 0 mg | |
| 50/50 with Prestone | visible precipitation | | |
| ELS | | | |
| D + BTFFCA mixed | No separation and no | 0 mg | |
| 50/50 with Prestone | visible precipitation | | |
| ELS | | | |
| A | | | Moderate deposit |
| | | | after heating, but less |
| | | | than by control |
| B | | | Light deposit after |
| | | | heating |
| C | | | Traces of deposit |
| | | | after heating |
| D + BTFFCA | | | Moderate deposit |
| | | | afer heating |

TABLE 16
Biodiesel Derived Glycerin & EG with NMOAT

| | 3.121 Storage | 3.122 Hot Storage | 3.123 Storage |
|---|---|---|---|
| | Stability of | Stability of | Stability of 50 |
| Mixture | Concentrate | Concentrate | Volume % Dilution |
| A + BTNMOAT | No separation and no | 0 mg | |
| | visible precipitation | | |
| B + BTNMOAT | No separation and no | 0 mg | |
| | visible precipitation | | |
| C + BTNMOAT | No separation and no | 0 mg | |
| | visible precipitation | | |
| D + BTNMOAT | No separation and no | 0 mg | |
| | visible precipitation | | |
| A + BTNMOAT mixed | No separation and no | 0 mg | |
| 50/50 with Prestone ELS | visible precipitation | | |
| B + BTNMOAT mixed | No separation and no | 0 mg | |
| 50/50 with Prestone ELS | visible precipitation | | |
| C + BTNMOAT mixed | No separation and no | 0 mg | |
| 50/50 with Prestone ELS | visible precipitation | | |
| D + BTNMOAT mixed | No separation and no | 0 mg | |
| 50/50 with Prestone ELS | visible precipitation | | |
| A | | | No separation and no |
| | | | visible precipitation |
| B | | | No separation and no |
| | | | visible precipitation |
| C | | | No separation and no |
| | | | visible precipitation |
| D + BTNMOAT | | | No separation and no |
| | | | visible precipitation |

TABLE 17
Biodiesel Derived Glycerin & PG with FFCA

| | 3.121 Storage | 3.122 Hot Storage | 3.123 Storage |
|---|---|---|---|
| | Stability of | Stability of | Stability of 50 |
| Mixture | Concentrate | Concentrate | Volume % Dilution |
| E + BTFFCA | No separation and no | 0 mg | |
| | visible precipitation | | |
| F + BTFFCA | No separation and no | 0 mg | |
| | visible precipitation | | |
| G + BTFFCA | No separation and no | 0 mg | |
| | visible precipitation | | |
| H + BTFFCA | No separation and no | 0 mg | |
| | visible precipitation | | |
| E + BTFFCA mixed | No separation and no | 0 mg | |
| 50/50 with Prestone | visible precipitation | | |
| ELS | | | |
| F + BTFFCA mixed | No separation and no | 0 mg | |
| 50/50 with Prestone | visible precipitation | | |
| ELS | | | |
| G + BTFFCA mixed | No separation and no | 0 mg | |
| 50/50 with Prestone | visible precipitation | | |
| ELS | | | |
| H + BTFFCA mixed | No separation and no | 0 mg | |
| 50/50 with Prestone | visible precipitation | | |
| ELS | | | |
| E | | | Moderate deposit after |
| | | | heating, but less than |
| | | | by control |
| F | | | Moderate deposit after |
| | | | heating, but less than |
| | | | by control |
| G | | | Light deposit after |
| | | | heating |
| H + BTFFCA | | | Moderate deposit after |
| | | | heating |
| E + BTNMOAT | No separation and no | 0 mg | |
| | visible precipitation | | |
| F + BTNMOAT | No separation and no | 0 mg | |
| | visible precipitation | | |
| G + BTNMOAT | No separation and no | 0 mg | |
| | visible precipitation | | |
| H + BTNMOAT | No separation and no | 0 mg | |
| | visible precipitation | | |
| E + BTNMOAT | No separation and no | 0 mg | |
| mixed 50/50 with | visible precipitation | | |
| Prestone ELS | | | |
| F + BTNMOAT | No separation and no | 0 mg | |
| mixed 50/50 with | visible precipitation | | |
| Prestone ELS | | | |
| G + BTNMOAT | No separation and no | 0 mg | |
| mixed 50/50 with | visible precipitation | | |
| Prestone ELS | | | |
| H + BTNMOAT | No separation and no | 0 mg | |
| mixed 50/50 with | visible precipitation | | |
| Prestone ELS | | | |
| E | | | No separation and no |
| | | | visible precipitation |
| F | | | No separation and no |
| | | | visible precipitation |
| G | | | No separation and no |
| | | | visible precipitation |
| H | | | No separation and no |
| | | | visible precipitation |

As shown in Tables 14-17, there were no observations wherein any mixture of biodiesel derived glycerin and EG or biodiesel derived glycerin and PG were less stable than the EG or PG controls. The above data supports a conclusion that biodiesel derived glycerin, when used as an engine coolant, will not contribute to any stability problems in use.

Corrosion Testing of Biodiesel Derived Glycerin by Adapted ASTM D1384 and D4340 Standards

ASTM D4340—“Standard Test Method for Corrosion of Cast Aluminum Alloys in Engine Coolants Under Heat-Rejecting Conditions”

Six different antifreeze formulations were prepared and evaluated under the conditions set forth by ASTM D4340. The ASTM D4340 test method covers a laboratory screening procedure for evaluating the effectiveness of engine coolants in combating corrosion of aluminum casting alloys under heat-transfer conditions that may be present in aluminum cylinder head engines. In the ASTM D4340 test method, a heat flux is established through a cast aluminum alloy typical of that used for engine cylinder heads while exposed to an engine coolant under a pressure of 193 kPa (28 psi). The temperature of the aluminum specimen is maintained at 135° C. (275° F.) and the test is continued for 1 week (168 h). The effectiveness of the coolant for preventing corrosion of the aluminum under heat-transfer conditions (hereinafter referred to as heat-transfer corrosion) is evaluated on the basis of the weight change of the test specimen.

Table 18 shows the results of tests using EG Nitrite, Borate, Silicate Conventional Technology Fully Formulated Coolants.

TABLE 18
Biodiesel derived Glycerin and Ethylene Glycol Nitrite, Borate,
Silicate Conventional Technology Fully Formulated Coolants

| | Average Weight | |
|---|---|---|
| | Loss/Corroision Rate | |
| Sample | (mg/cm2/week) | Average pH After |
| A | −0.06 | 7.3 |
| B | 0.26 | 7.46 |
| C | 0.07 | 7.02 |

Table 19 shows the results of tests using Ethylene Glycol Nitrite, Molybdate Organic Acid Technology Extended Life Fully Formulated Extended Service Interval Coolants

TABLE 19
Biodiesel Derived Glycerin and Ethylene Glycol Nitrite,
Molybdate Organic Acid Technology Extended Life
Fully Formulated Extended Service Interval Coolants

| | Average Weight | |
|---|---|---|
| | Loss/Corroision Rate | |
| Sample | (mg/cm2/week) | Average pH After |
| A | 0.02 | 7.29 |
| B | 0.01 | 7.23 |
| C | 0.02 | 6.48 |

Table 20 shows test results using biodiesel derived glycerin and Propylene Glycol Nitrite, Borate, Silicate Conventional Technology Fully Formulated Coolants.

TABLE 20
Biodiesel Derived Glycerin and Propylene Glycol Nitrite, Borate,
Silicate Conventional Technology Fully Formulated Coolants

| | Average Weight | |
|---|---|---|
| | Loss/Corroision Rate | |
| Sample | (mg/cm2/week) | Average pH After |
| E | −0.04 | 8.07 |
| F | 0.02 | 7.43 |
| G | 0.08 | 7.13 |

Table 21 shows test results using biodiesel derived glycerin and Propylene Glycol Nitrite, Molybdate Organic Acid Technology Extended Life Fully Formulated Extended Service Interval Coolants

TABLE 21
Biodiesel Derived Glycerin and Propylene Glycol Nitrite,
Molybdate Organic Acid Technology Extended Life
Fully Formulated Extended Service Interval Coolants

| | Average Weight | |
|---|---|---|
| | Loss/Corroision Rate | |
| Sample | (mg/cm2/week) | Average pH After |
| E | 0.01 | 7.37 |
| F | −0.08 | 6.90 |
| G | −0.02 | 6.70 |

ASTM D1384-“Standard Test Method for Corrosion Test for Engine Coolants in Glassware”

Six different antifreeze formulations were prepared and evaluated under the conditions set forth by ASTM D1384. ASTM D1384 is a standard test method for general corrosion of a variety of metals typically found in the cooling and/or heating systems of internal combustion engines. The ASTM D1384 test method covers a simple beaker-type procedure for evaluating the effects of engine coolants on metal specimens under controlled laboratory conditions. In the ASTM D1384 test method, specimens of metals typical of those present in engine cooling systems are totally immersed in aerated engine coolant solutions prepared with corrosive salts for 336 hours at 88° C. (190° F.). The corrosion inhibition properties of the test solution are evaluated on the basis of the weight changes incurred by the specimens. Each test is run in triplicate, and the average weight change is determined for each metal. This test method will generally distinguish between coolants that are definitely deleterious from the corrosion standpoint and those that are suitable for further evaluation.

Automobile manufacturers have accepted the specimens prescribed in this test method, but their composition may not be the same as that of alloys currently used for engine cooling system components. Therefore, specimens other than those designated in this test method may be used by mutual agreement of the parties involved. The following metal test specimens, 1 by 2 inches in size, representative of cooling system metals, were used:
Steel, UNS G10200 (SAE 1020), Chemical composition of the carbon steel is as follows: carbon, 0.17 to 0.23%; manganese, 0.30 to 0.60%; phosphorus, 0.040% maximum; sulfur, 0.050% maximum.
Copper, conforming to UNS C11000 (SAE CA110) or UNS C11300 (SAE CA113). Cold-rolled.
Brass, conforming to Alloy UNS C26000 (SAE CA 260).
Solder, A brass specimen as described in 6.1.3, coated with solder conforming to Alloy Grade 30A (SAE 3A)
Cast Aluminum, conforming to Alloy UNS A23190 (SAE 329).
Cast Iron, conforming to Alloy UNS F10007 (SAE G3500).

After preparing the formulations and subjecting them to the test procedures set forth in ASTM D1384 (the metal specimens are immersed for 336 hours in the antifreeze formulation and maintained at a temperature of 88° C. (190° F.)). The weight change of the metal specimens was measured (average of triplicate specimens). A negative weight loss signifies a weight increase due to the formation of a protective coating on the metal surfaces.

TABLE 22
Metal Weight Loss (mg) of Biodiesel Derived Glycerin and Ethylene
Glycol Nitrite, Borate, Silicate Conventional Technology Fully
Formulated Coolants tested according to ASTM D1384

| | | ASTM | | | | Aluminum |
|---|---|---|---|---|---|---|
| Example | Copper | Solder | Brass | Steel | Iron | 319 |
| A | 3 | 3 | 2 | 1 | 1 | 0 |
| B | 4 | 7 | 3 | 1 | 1 | 0 |
| C | 4 | 2 | 3 | 1 | 1 | 0 |

TABLE 23
Metal Weight Loss (mg) of Biodiesel Derived Glycerin and Ethylene
Glycol Nitrite, Molybdate Organic Acid Technology Fully Formulated
Extended Service Interval Coolants

| | | ASTM | | | | Aluminum |
|---|---|---|---|---|---|---|
| Example | Copper | Solder | Brass | Steel | Iron | 319 |
| A | 2 | 8 | 1 | 1 | 0 | 4 |
| B | 2 | 4 | 1 | 1 | 0 | 3 |
| C | 2 | 1 | 2 | 1 | 0 | 6 |

TABLE 24
Metal Weight Loss (mg) of Biodiesel Derived Glycerin and Propylene
Glycol Nitrite, Borate, Silicate Conventional Technology Fully
Formulated Coolants

| | | ASTM | | | | Aluminum |
|---|---|---|---|---|---|---|
| Example | Copper | Solder | Brass | Steel | Iron | 319 |
| E | 1 | 6 | 1 | 0 | 2 | 1 |
| F | 0 | 1 | 1 | 0 | 2 | 1 |
| G | 1 | 2 | 1 | 0 | 0 | 0 |

TABLE 25
Metal Weight Loss (mg) of Biodiesel Derived Glycerin and Propylene
Glycol Nitrite, Molybdate Organic Acid Technology Fully Formulated
Extended Service Interval Coolants

| | | ASTM | | | | Aluminum |
|---|---|---|---|---|---|---|
| Example | Copper | Solder | Brass | Steel | Iron | 319 |
| E | 0 | 8 | 0 | 0 | 0 | 9 |
| F | 0 | 3 | 0 | 1 | 0 | 9 |
| G | 1 | 1 | 1 | 2 | 0 | 7 |

The data from the compatibility tests above in Tables 18-25 suggest that marketing glycerin-based and glycerin-blend coolants would require little consumer behavior adaptation. One concern of introducing glycerin into the engine coolant market is that there may be some negative behavior if it is mixed, as it inevitable will be, with existing coolants that are based on ethylene glycol and propylene glycol. The above experiments were undertaken to learn if any negative corrosion behaviors might be identified. No negative behaviors were observed. The tests were performed at various glycerin concentrations and were also performed with several dissimilar coolant corrosion inhibitor chemistries that are used in major automotive manufacturing facilities. This provided a good breadth of exposure, allowing a reasonable conclusion that the glycerin is compatible with existing coolants in the market, regardless of the freeze depressant or corrosion inhibition package that is used.

Preferably, in place of propylene glycol, glycerin is used to create an essentially non-toxic antifreeze/coolant. Glycerin is a low cost alternative to propylene glycol. In large systems this presents a major cost advantage for coolant when compared to propylene glycol. Preferably, glycerin is marketed for use in commercial heating & cooling systems, food warehouse chiller systems, foodstuff transport vehicles, and drinking water heating systems. Preferably, glycerin based coolants may replace “brine” heating and cooling systems. While more expensive than salt water the long term costs might be less when component durability is factored in. Components used in and around brine-water systems are often replaced after suffering damage from corrosion induced by the brine solutions.

Preferably, glycerin systems 100 comprises an inhibited glycerin (biodiesel derived glycerin) for use as engine coolant (antifreeze) using percentages suggested by the above data. Preferably, glycerin systems 100 comprise inhibited blends of glycerin and ethylene glycol for use as engine coolant (antifreeze). Preferably, glycerin systems 100 comprises inhibited blends of glycerin and propylene glycol for use as cost-effective low-toxicity engine coolant (antifreeze). Preferably, glycerin systems 100 comprises inhibited blends of glycerin and propylene glycol for use as cost-effective low-toxicity HVAC fluids (heat exchange fluids). Preferably, glycerin systems 100 comprises inhibited blends of glycerin and propylene glycol for use as cost-effective low-toxicity drilling fluids. Preferably, glycerin systems comprises inhibited glycerin (bio-glycerin) for use as cost-effective low-toxicity drilling fluids. Although applicant has described applicant's preferred embodiments of this invention, it will be understood that the broadest scope of this invention includes modifications such as diverse shapes, sizes, and materials. Such scope is limited only by the below claims as read in connection with the above specification. Further, many other advantages of applicant's invention will be apparent to those skilled in the art from the above descriptions and the below claims.

What is claimed is:

1) A method, comprising the steps of:
a) manufacturing biodiesel;
b) collecting the byproduct glycerin of such biodiesel manufacturing;
c) adding at least one anticorrosive additive to such glycerin to generate at least one antifreeze; and
d) placing such at least one antifreeze into at least one automotive cooling system.

2) The method, according to claim 1, further comprising the step of adding water to such at least one antifreeze.

3) A method, comprising the steps of:
a) collecting convertible oils from animal and/or vegetable sources;
b) converting such convertible oils into biodiesel and glycerin; and
c) adding at least one anticorrosive additive to such glycerin to produce at least one antifreeze.

4) The method, according to claim 3, further comprising the step of adding water to such at least one antifreeze.

5) The method, according to claim 3, further comprising the step of using such at least one antifreeze in at least one automobile.

6) The method, according to claim 3, further comprising the step of using such at least one antifreeze in at least one diesel truck.

7) The method, according to claim 3, further comprising the step of using such at least one antifreeze in at least one industrial heat exchanger.

8) The method, according to claim 3, further comprising the step of marketing such at least one antifreeze as “biodiesel-derived” antifreeze.

9) The method, according to claim 3, further comprising the step of marketing such at least one antifreeze as “green glycerin”.

10) The method, according to claim 3, further comprising the step of marketing such at least one antifreeze as “green glycerine”.

11) The method, according to claim 3, further comprising the step of marketing such at least one antifreeze as “green” antifreeze.

12) The method, according to claim 3, further comprising the step of marketing such at least one antifreeze as “eco-friendly” antifreeze.

13) The method, according to claim 3, further comprising the step of packaging such at least one antifreeze in at least one green bottle.

14) The method, according to claim 3, further comprising the step of packaging such at least one antifreeze with at least one green label.

15) The method, according to claim 3, further comprising the step of providing wholesale sales and distribution of such at least one antifreeze.

16) The method, according to claim 3, further comprising the step of selling such at least one antifreeze in USDA hardiness zones 7a-11.

17) The method, according to claim 3, further comprising the step of selling such at least one antifreeze in USDA hardiness zones 5a-11.

18) The method, according to claim 3, further comprising the step of certifying such at least one antifreeze as meeting ASTM D 3306—Standard Specification for Glycol Base Engine Coolant for Automobile and Light-Duty Service.

19) The method, according to claim 3, further comprising the step of certifying such at least one antifreeze as meeting ASTM D 2610—Standard Specification for Fully-Formulated Glycol Base Engine Coolant for Heavy-Duty Engines.

20) The method, according to claim 3, further comprising the step of adjusting the viscosity of such at least one antifreeze to between the viscosity of at least one propylene-glycol-based antifreeze and the viscosity of at least one ethylene-glycol-based antifreeze.

21) The method, according to claim 3, further comprising the step of approximately matching the viscosity of such at least one antifreeze to the viscosity of at least one propylene-glycol-based antifreeze.

22) The method, according to claim 3, further comprising the step of approximately matching the viscosity of such at least one antifreeze to the viscosity of at least one ethylene-glycol-based antifreeze.

23) The method, according to claim 3, further comprising the step of replacing an ethylene glycol based coolant in a heat exchange system, over at least one interval of time, with such glycerin comprising antifreeze.

24) The method, according to claim 3, further comprising the step of replacing a propylene glycol based coolant in a heat exchange system, over at least one interval of time, with such glycerin comprising antifreeze.

25) The method, according to claim 3, further comprising the step of replacing a brine based coolant in a heat exchange system, over at least one interval of time, with such glycerin comprising antifreeze.

26) The product manufactured by the process of claim 3.

27) The product manufactured by the process of claim 21.

28) The product manufactured by the process of claim 22.

29) An antifreeze, adapted to have a viscosity between the viscosity of 50% ethylene glycol antifreeze and the viscosity of 50% propylene glycol antifreeze, comprising glycerin.

30) The antifreeze, according to claim 28, adapted to have the viscosity of 50% ethylene glycol based antifreeze.

31) The antifreeze, according to claim 28, adapted to have the viscosity of 50% propylene glycol based antifreeze.

32) The antifreeze, according to claim 28, wherein said glycerin comprises biodiesel-derived glycerin.

33) A glycerin based antifreeze comprising:
a) about 55 percent volume of biodiesel derived glycerin;
b) about 40 percent volume deionized water; and
c) about 3.5% v/v Nitrite, Molybdate Organic Acid Technology Fully Formulated Extended Service Interval Coolant.

34) A glycerin based antifreeze comprising:
a) about 55 percent volume biodiesel derived glycerin;
b) about 43 percent volume deionized water; and
c) about 1 percent fully formulated conventional antifreeze additive.

35) A blended coolant/antifreeze comprising:
a) at least 25 percent volume bio-diesel derived glycerin; and
b) at least one amount of ethylene glycol.

36) The blended coolant/antifreeze, according to claim 34, comprising at least 50 percent biodiesel derived glycerin.

37) The blended coolant/antifreeze, according to claim 35, comprising at least 75 percent biodiesel derived glycerin.

38) A blended coolant/antifreeze comprising:
a) at least 25 percent biodiesel derived glycerin; and
b) at least one amount of propylene glycol.

39) The blended coolant/antifreeze, according to claim 38, comprising at least 50 percent biodiesel derived glycerin.

40) The blended coolant/antifreeze, according to claim 38, comprising at least 75 percent biodiesel derived glycerin.

41) A blended coolant/antifreeze comprising:
a) at least one amount of biodiesel derived glycerin;
b) at least one amount of ethylene glycol; and
c) at least one amount of at least one anti-corrosive additive.

42) The blended coolant/antifreeze, according to claim 41,
a) wherein said at least one amount of at least amount of biodiesel derived glycerin comprises about 25 percent biodiesel derived glycerin; and
b) wherein said at least one amount of ethylene glycol comprises about 75 percent ethylene glycol.

43) The blended coolant/antifreeze, according to claim 41,
a) wherein said at least one amount of at least amount of biodiesel derived glycerin comprises about 50 percent biodiesel derived glycerin; and
b) wherein said at least one amount of ethylene glycol comprises about 50 percent ethylene glycol.

44) The blended coolant/antifreeze, according to claim 41,
a) wherein said at least one amount of at least amount of biodiesel derived glycerin comprises about 75 percent biodiesel derived glycerin; and
b) wherein said at least one amount of ethylene glycol comprises about 25 percent ethylene glycol.

45) A blended coolant/antifreeze comprising:
a) at least one amount of biodiesel derived glycerin;
b) at least one amount of propylene glycol; and
c) at least one amount of at least one anti-corrosive additive.

46) The blended coolant/antifreeze, according to claim 45,
a) wherein said at least one amount of at least amount of biodiesel derived glycerin comprises about 25 percent biodiesel derived glycerin; and
b) wherein said at least one amount of propylene glycol comprises about 75 percent propylene glycol.

47) The blended coolant/antifreeze, according to claim 45,
a) wherein said at least one amount of at least amount of biodiesel derived glycerin comprises about 50 percent biodiesel derived glycerin; and
b) wherein said at least one amount of propylene glycol comprises about 50 percent propylene glycol.

48) The blended coolant/antifreeze, according to claim 45,
a) wherein said at least one amount of at least amount of biodiesel derived glycerin comprises about 75 percent biodiesel derived glycerin; and
b) wherein said at least one amount of propylene glycol comprises about 25 percent propylene glycol.
